(19) United States
(12) Patent Application Publication
(10) Pub. No.: US 2025/0040564 A1
(43) Pub. Date: Feb. 6, 2025

(54) SENSORY MODIFIERS FOR REDUCED SUGAR COCOA COMPOSITIONS

(71) Applicant: CARGILL, INCORPORATED, Wayzata, MN (US)

(72) Inventors: Alexandra Jean FIEGEL, Albertville, MN (US); Daniel Scott GASPARD, Victoria, MN (US); Smaro Germann KOKKINIDOU, Minneapolis, MN (US); Rama Krishna SARANGAPANI, St. Micheal, MN (US); Wade Nolan SCHMELZER, St. Louis Park, MN (US); Adam T. ZARTH, Golden Valley, MN (US)

(73) Assignee: CARGILL, INCORPORATED, Wayzata, MN (US)

(21) Appl. No.: 18/715,942

(22) PCT Filed: Dec. 16, 2022
(86) PCT No.: PCT/US2022/081888

§ 371 Date: Jun. 3, 2024

Related U.S. Application Data
(60) Provisional application No. 63/265,636, filed on Dec. 17, 2021.

(51) Int. Cl. A23G 1/40; A23G 1/46; A23G 1/48; A23G 9/34; A23G 9/40; A23G 9/42; A23L 2/56; A23L 2/60; A23L 27/00; A23L 27/20

(52) U.S. Cl. CPC A23G 1/40; A23G 1/46; A23G 1/48; A23G 9/34; A23G 9/40; A23G 9/42; A23L 2/56; A23L 2/60; A23L 27/204; A23L 27/88

(57) ABSTRACT

A cocoa composition including cocoa liquor, cocoa powder, or combinations thereof, milk solids, milk solid alternatives, or combinations thereof, a sugar substitute, and a sensory modifier and with reduced bitterness, reduced cooked milk flavor, increased cocoa flavor, and/or increased cream flavor relative to an equivalent composition without the sensory modifier is described herein. The sensory modifier may include a dicaffeoylquinic acid or salt thereof; and one or more compounds selected from the group consisting of monocaffeoylquinic acids, monoferuloylquinic acids, diferuloylquinic acids, monocoumaroylquinic acids, dicoumaroylquinic acids, and salts thereof.

### CROSS-REFERENCE TO RELATED APPLICATIONS

This application claims the benefit of U.S. Provisional Application No. 63/265,636, filed Dec. 17, 2021, which is incorporated by reference herein in its entirety.

### BACKGROUND

Within the food and beverage industry, there continues to be efforts to reduce the amount of caloric sugars, such as sucrose, fructose, and/or glucose, in products. While sugar substitutes can provide a sweetened taste to products, there can be limitations to preparing products with sugar substitutes. For example, consumers may find that the sensory and temporal characteristics of sugar substitutes differ from those found in caloric sweeteners such as glucose, sucrose, and/or fructose. These sensory characteristics can limit the use of sugar substitutes in products and become increasingly limiting as the concentration of sugar substitute increases.

### SUMMARY

The present disclosure provides compositions containing cocoa liquor, cocoa powder, or combinations thereof, milk solids, milk solid alternatives or combinations thereof, a sugar substitute; and a sensory modifier comprising a dicaffeoylquicid acid or salt thereof, and at least one compound selected from the group consisting of monocaffeoylquinic acids, monoferuloylquinic acids, diferuloylquinic acids, monocoumaroylquinic acids, dicoumaroylquinic acids, and salts thereof. The sugar substitute may be selected from the group consisting of steviol glycosides, mogrosides, sucralose, acesulfame K, aspartame, saccharin, erythritol, maltitol, lactitol, sorbitol, mannitol, xylitol, allulose, and combinations thereof. The sugar constitute may comprise a steviol glycoside. The sugar substitute may comprise a steviol glycoside selected from the group consisting of rebaudioside M, rebaudioside D, rebaudioside A, and combinations thereof. The steviol glycoside and the sensory modifier may be present in the composition at a ratio between 1:0.3 and 1:3, between 1:0.5 and 1:2, or between 1:0.75 and 1:1.5; or wherein the steviol glycoside sweetener and the sensory modifier are present in the composition at a ratio of about 1:1. The composition may additionally comprise cocoa butter. The composition may comprise at least 2% by weight, at least 3% by weight, or at least 5% by weight non-fatty cocoa solids. The composition may comprise at least 5% by weight, at least 8% by weight, or at least 10% by weight non-fatty milk solids. The composition may additionally comprise an emulsifier. The composition may additionally comprise a bulking agent.

The sensory modifier may comprise less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than 0.05% (wt) of chlorophyll; or less than 0.1% (wt) of furans, furan-containing chemicals, theobromine, theophylline, or trigonelline as a weight percentage on a dry weight basis of the sensory modifier. The sensory modifier may comprise 0% (wt) of malonate, malonic acid, oxalate, oxalic acid, lactate, lactic acid, succinate, succinic acid, malate, or malic acid; or 0% (wt) of chlorophyll. The dicaffeoylquinic acid or dicaffeoylquinic salt may comprise at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof. The total of all dicaffeoylquinic acids and dicaffeoylquinic salts present in the sensory modifier may comprise 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the sensory modifier. The sensory modifier may comprise a monocaffeoylquinic component selected from the group consisting of chlorogenic acid, neochlorogenic acid, cryptochlorogenic acid, and salts thereof. The sensory modifier may comprise a monocaffeoylquinic component and a dicaffeoylquinic component that together comprise more than 50% (wt), preferably more than 60% (wt), more than 70% (wt), more than 80% (wt), more than 90% (wt), or more than 95% (wt) of the sensory modifier.

Cocoa flavor and/or cream flavor of the composition may be increased relative to an equivalent composition lacking the sensory modifier. Cocoa flavor score and/or cream flavor score of the composition may be increased by at least 0.5 units, at least 1 unit, at least 2 units, or at least 3 units relative to an equivalent composition lacking the sensory modifier, wherein the cocoa flavor score and/or cream flavor score are determined by at least four panelists experienced in sensory testing using a roundtable methodology using a scale of 0 to 9 with a score of 0 indicating no flavor and a score of 9 indicating extreme flavor.

Cooked milk flavor of the composition may be decreased relative to an equivalent composition lacking the sensory modifier. Cooked milk flavor score of the composition is decreased by at least 0.5 units, at least 1 unit, at least 2 units, or at least 3 units relative to an equivalent composition lacking the sensory modifier, wherein the cooked milk flavor score is determined by at least four panelists experienced in sensory testing using a roundtable methodology using a scale of 0 to 9 with a score of 0 indicating no cooked milk flavor and a score of 9 indicating extreme cooked milk flavor.

The disclosure also provides a food or beverage composition comprising the cocoa compositions described herein.

The disclosure also provides a method for increasing cocoa flavor and/or cream flavor in a cocoa composition, the method comprising, adding to a cocoa composition a sensory modifier comprising a dicaffeoylquicid acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof, wherein the cocoa composition comprises (i) cocoa powder, cocoa liquor, or combinations thereof, and (ii) milk solids, milk solids alternatives, or combinations thereof, and wherein cocoa flavor and/or cream flavor is increased relative to an equivalent cocoa composition lacking the sensory modifier. The sensory modifier is added to the cocoa composition in an amount effective to increase the cocoa flavor and/or cream flavor by at least 1 unit relative a comparable composition lacking the sensory modifier, wherein the cocoa flavor score and/or cream flavor score are determined by at least four panelists experienced in sensory testing using a roundtable methodology using a scale of 0 to 9 with a score of 0 indicating no flavor and a score of 9 indicating extreme flavor.

The disclosure also provides a method for reducing cooked milk flavor in a cocoa composition, the method comprising, adding to a cocoa composition a sensory modifier comprising a dicaffeoylquicid acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof, wherein the cocoa composition comprises (i) cocoa powder, cocoa liquor, or combinations thereof, and (ii) milk solids, milk solids alternatives, or combinations thereof, and wherein cooked milk flavor is reduced relative to an equivalent cocoa composition lacking the sensory modifier. The sensory modifier may be added to the cocoa composition in an amount effective to reduce the cooked milk flavor by at least 1 unit relative to a comparable composition lacking the sensory modifier, wherein the cooked milk flavor score is determined by at least four panelists experienced in sensory testing using a roundtable methodology using a scale of 0 to 9 with a score of 0 indicating no cooked milk flavor and a score of 9 indicating extreme cooked milk flavor.

The disclosure also provides a use of a sensory modifier to increase cocoa flavor and/or cream flavor in a cocoa composition, wherein the sensory modifier comprises a dicaffeoylquicid acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof. The cocoa composition may comprise (i) cocoa powder, cocoa liquor, or combinations thereof; and (ii) milk solids, milk solids alternatives, or combinations thereof.

### BRIEF DESCRIPTION OF THE FIGURES

This patent or application contains at least one drawing executed in color. Copies of this patent or patent application publication with color drawings will be provided by the Office upon request and the payment of the necessary fee.

The drawings illustrate generally, by way of example, but not by way of limitation, various aspects discussed herein.

FIG. 1 shows a photo of milk chocolate coating compositions as described in Example 1.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

This disclosure relates to various cocoa compositions which have improved sensory attributes, such as reduced bitterness, improved sweetness temporal profile, reduced cooked milk flavor, increased cocoa flavor, increased cream flavor, and the like. The disclosure further relates to compositions, such as food and beverage compositions, made with the cocoa compositions, the food and beverage compositions having improved sensory attributes such as reduced bitterness, reduced cooked milk flavor, increased cocoa flavor, increased cream flavor, and the like. The disclosure also relates, generally, to a sensory modifier and uses thereof. In various aspects, the sensory modifier contains one or more caffeoyl-substituted quinic acid, and salts thereof.

### Compositions

The present disclosure provides cocoa compositions containing a non-nutritive sweetener with various improvements which serve to modify the sensory perception thereof in use. In general, the cocoa composition will include a non-nutritive sweetener and a sensory modifier that improves one or more sensory attributes of the cocoa composition relative to an equivalent cocoa composition lacking the sensory modifier.

As used herein, “cocoa composition” refers to a composition comprising cocoa liquor and/or cocoa powder. The cocoa composition may additionally include cocoa butter and/or cocoa butter replacers, equivalents, improvers, and/or substitutes. The cocoa composition may be substantially homogeneous.

Cocoa beans are composed of a fatty component, known as cocoa butter, and non-fatty components, which are typically present in cocoa liquor and cocoa powder. As used herein, “non-fatty cocoa solids” refers to any non-fat component derived from cocoa beans, typically present in cocoa liquor and cocoa powder. When expressing the amount of non-fatty cocoa solids in a composition, it represents the total amount of all such components present in the composition from any source. In general, the cocoa compositions described herein include non-fatty cocoa solids in an amount of at least 2% by weight, at least 3% by weight, at least 5% by weight, at least 10% by weight, or at least 15% by weight. For example, the composition may comprise non-fatty cocoa solids in an amount of 2-50% by weight, 3-45% by weight, 4-40% by weight, or 5-35% by weight.

Cocoa liquor, also known in the art as “cocoa mass,” is produced from ground cocoa beans. Prior to or after grinding, the beans may be fermented, dried, roasted, alkalized and/or treated using any other technique known in the art. Cocoa compositions described herein may include 5-30% by weight, 10-25% by weight, 10-20% by weight, or 10-15% by weight cocoa liquor.

Cocoa butter is the fat extracted from cocoa beans, typically be pressing the cocoa liquor. Cocoa butter may be deodorized to remove strong or undesirable tastes or aromas. Cocoa butter may be replaced, in whole or in part, by cocoa butter alternatives. Cocoa butter alternatives are well known in the art and include cocoa butter replacers, cocoa butter equivalents, cocoa butter improvers, and cocoa butter substitutes. They are typically vegetable fats and/or vegetable fat fractions with similar physical or chemical properties to cocoa butter. The cocoa compositions described herein may include at least 18% by weight, at least 20% by weight, at least 25% by weight cocoa butter and/or cocoa butter alternatives. For example, it may include between 20% and 40%, or between 25% and 35% cocoa butter by weight.

Cocoa powder is produced by further grinding or milling the “dry” residue obtained from cocoa liquor after pressing. It may be natural cocoa powder, with a pH of around 5.5, or it may be processed (e.g., treated with alkali or acid). It may have a relatively high fat content, e.g. above 15% by weight residual cocoa butter, a standard fat content (e.g. 10-15% by weight cocoa butter), or a low fat content (less than 10% by weight cocoa butter). Fat-free cocoa powders may also be used (e.g., with a fat content of less than 2% by weight).

The cocoa compositions described herein may be a chocolate composition. Herein, the terms “chocolate composition” and “chocolate” may be used interchangeably. As used herein, the teams “chocolate composition” and “chocolate” are not limited to any particular legal definitions of chocolate, such as the legal definitions provided in Directive 2000/36/EC of the European Parliament and of the Council of 23-6-2000 or in Title 21 of the United States Code of Federal Regulations, Part 163 Cacao Products (21 C.F.R. 163). If the cocoa composition is a chocolate composition, it may include non-fatty cocoa solids and cocoa butter together in an amount of at least 30% by weight, at least 33% by weight, or at least 35% by weight. Alternatively, it may include non-fatty cocoa solids and cocoa butter together in an amount of at least 40% by weight, at least 43% by weight, at least 45% by weight. A chocolate composition as described herein may include at least 26% cocoa butter by weight, at least 28% cocoa butter by weight, or at least 30% cocoa butter by weight.

The cocoa composition described herein may be a coating or compound type compositions. A coating or compound type composition may include one or more cocoa butter alternatives instead of or as well as cocoa butter. Such coating or compound cocoa compositions may include non-fatty cocoa solids in an amount from 2 to 20% by weight, from 3 to 18% by weight, or from 3 to 15% by weight.

The cocoa compositions may be a dairy-based cocoa composition that includes milk fat and/or non-fatty milk solids, or it may be a dairy-reduced or dairy-free cocoa composition including milk solids alternatives (in addition to or instead of milk fat and/or non-fatty milk solids). As used herein, the terms “dairy-reduced” or “dairy-free” cocoa compositions refer to the compositions that have either a reduced diary content or are diary-free, but maintain some or all of the sensory characteristics of dairy cocoa compositions, such as creamy texture, appearance, and/or taste. As such, and for simplicity, these dairy-reduced and dairy-free alternatives will also be referred to herein as “diary-based cocoa compositions.”

As used herein, “milk solids” refer to ingredients obtained by partly or wholly dehydrating whole milk, semi- or fully-skimmed milk, cream, or from partly or wholly dehydrated cream, butter, or milk fat, and any derivatives thereof including, but not limited to, milk fat fractions, lactose, whey, whey powder, caseinate, and/or milk hydrolysates. Milk solids may include both fatty milk solids (also referred to as milk fat) and non-fatty milk solids. Dairy-based cocoa compositions may comprise at least 5%, at least 8%, at least 10%, at least 15%, at least 18%, or at least 20% milk solids or milk solids alternatives by weight. Dairy-based cocoa compositions may include at least 5%, at least 8%, at least 10%, at least 15%, at least 18%, or at least 20% non-fatty milk solids. As used herein, the ingredient “milk” refers to the milks of animal and particularly mammalian origin (e.g., cow, buffalo, sheep, and/or goat milk). Milk solids alternatives may include non-animal-based alternatives including, but not limited to, almond milk powder, oat milk powder, coconut milk powder, soy milk powder, pea protein, pea flour, rice milk powder, cashew milk powder, potato milk powder, combinations thereof, and the like.

The cocoa composition may be a powder, a solid composition, a moldable composition, or the like. The cocoa composition may be a liquid, a syrup, a gel, or the like.

As used herein, “moldable” refers to a composition that is capable of being formed into a shape in a mold, setting (e.g., at room temperature), and then retaining the molded shape after removal of the mold. For example, the compositions of the invention may be in a solid form after being molded. The moldable cocoa compositions described herein may have a water content of less than 10% by weight based on the total weight of the composition. The cocoa compositions described herein may have a water content of less than 5%, less than 3%, less than 2%, or less than 1% by weight.

The cocoa composition described herein may contain a sweetener. Suitable sweeteners are known and described in the art. The cocoa composition may include a caloric sweetener, a non-nutritive sweetener, or combinations thereof. The sweetener can be any type of sweetener, for example, a sweetener obtained from a plant or plant product, or a physically or chemically modified sweetener obtained from a plant, or a synthetic sweetener. Suitable sweeteners and aspects thereof are also described in PCT International Publication Nos. WO 2019/071220 and WO 2019/071182 and in US Patent Application Publication Nos. 2019/0223481 and 2019/0223483, each of which is incorporated by reference herein in its entirety.

As used herein, “caloric sweeteners” refer to ingredients that add both sweetness and calories to the compositions to which they are added. Caloric sweeteners include, but are not limited to, trehalose, glucose, dextrose, fructose, galactose, sucrose, lactose, maltose, palatinose, isomaltulose, cane sugar, beet sugar, rice syrup, invert sugar, honey, agave syrup, maple syrup, high fructose corn syrup, combinations thereof, and the like. The term “sucrose” as used herein includes sucrose in various forms including but not limited to standard (e.g. granulated or crystalline) table sugar, powdered sugar, caster sugar, icing sugar, sugar syrup, silk sugar, unrefined sugar, raw sugar cane, and molasses. Preferably, the caloric sweetener is sucrose.

As used herein, “sugar substitute” refers to a low-calorie sweetener or a no-calorie sweetener.

As used herein, “low-calorie sweetener” refers to sweeteners that have the same or lower intensity of sweetness per gram than sucrose but fewer calories. For example, suitable mow-calorie sweeteners may include, but are not limited to, isomalt, tagatose, erythritol, maltitol, lactitol, sorbitol, mannitol, allulose, xylitol, hydrogenated starch hydrolysates, combinations thereof, and the like. Preferably, the low-calorie sweetener is a sugar alcohol. More preferably, the low-calorie sweetener is erythritol or maltitol.

As used herein, “no-calorie sweetener” refers to sweeteners that have no calories, or do not add calories to the compositions to which they are added due to their low usage levels, but have higher intensity of sweetness per gram than sucrose. No-calorie sweeteners may also be known in the art as high intensity sweeteners or high potency sweeteners. No-calorie sweeteners may include, but are not limited to, steviol glycosides, mogrosides, sucralose, acesulfame potassium (acesulfame K), aspartame, saccharin, brazzein, combinations thereof, and the like. Preferably the no-calorie sweetener is or comprises steviol glycosides.

The cocoa compositions described herein may have a lower content of total sugars than equivalent, traditionally manufactured compositions, on an equivalent weight or volume basis. The terms “total sugars” and “total sugar content” are used interchangeably herein and refer to the sum of all caloric sweeteners in the composition. This may include sugars that are intentionally added to the chocolate as well as sugars that are intrinsic to other ingredients in the chocolate. To comply with legal standards for reduced-sugar chocolates, the content of total sugars in the cocoa compositions described herein may have at least 30% less than that of equivalent commercial chocolates. The cocoa composition described herein may have a total sugar content of 45% or less, 40% or less, 35% or less, 30% or less, 25% or less, 20% or less, 15% or less, or 10% or less by weight. The cocoa compositions described herein may be sugar-free compositions or they may be a composition which includes no added sugar (e.g., no added caloric sweeteners). The cocoa composition may include less than 5%, less than 2%, less than 1%, or less than 0.5% total sugars.

The cocoa compositions described herein may additionally include one or more bulking agents, plasticizing ingredients, emulsifiers, flavorings, or combinations thereof.

Suitable bulking agents include, but are not limited to, oligosaccharides (such as fructo-oligosaccharides (kestose, nystose, and the like), nigero-oligosaccharides, xylo-oligosaccharides (xylotriose, xylobiose and the like), gentio-oligoscaccharides (gentiobiose, gentiotriose, gentiotetraose and the like), galacto-oligosaccharides, tetrasaccharides, mannan-oligosaccharides, malto-oligosaccharides (maltotriose, maltotetraose, maltopentaose, maltohexaose, maltoheptaose and the like), soybean oligosaccharides, and the like), polysaccharides (such as starch and starch-derivatives including maltodextrin, dextrins, and glucose syrup; fructan; inulin; polydextrose; pectin and the like), insoluble fibers (such as resistant starches, cereal fibers, grain fibers, fruit fibers, and legume fibers), sugar alcohols (such as erythritol, maltitol, lactitol, sorbitol, mannitol, xylitol), rare sugar (such as allulose, tagatose, and the like) and combinations thereof. In some aspects, the bulking agent may be selected from the group consisting of vegetable fibers, dextrin, maltodextrin, polydextrose, inulin, dehydrated grain syrups (such as dried rice syrup), pectin, sugar alcohols, and combinations thereof. Preferably, the bulking agent is a sugar alcohol. Bulking agents may be added to the cocoa composition in am amount of up to 75%, up to 70%, up to 65%, up to 60%, up to 55%, up to 50%, up to 45%, up to 40%, up to 35%, up to 30%, up to 25%, up to 20%, up to 15%, or up to 10% by weight of the composition. The cocoa compositions described herein may include a bulking agent in an amount of 0.5% to 75%, 1% to 60%, 2% to 55%, or 3% to 50% by weight. In some aspects, an ingredient may function as both a sweetener and a bulking agent in a composition, such as erythritol, maltitol, lactitol, sorbitol, mannitol, xylitol, allulose, and tagatose.

Plasticizing ingredients may be added to the cocoa compositions described herein to reduce brittleness and/or to give it a creamier mouthfeel. Suitable plasticizing ingredients may include, but are not limited to, vegetable fats and oils, in particular those with a melting point below that of cocoa butter (such as palm oil, palm kernel oil, shea butter, and nut oils such as almond or hazelnut oil), randomized vegetable fats (such as fully or partially chemically and/or enzymatically interesterified fats), vegetable fat fractions (especially low melting point fractions), so-called “soft” cocoa butters (such as those obtained from Brazilian cocoa bean varieties), and combinations thereof. Suitable plasticizing ingredients will preferably not include hydrogenated fats. In some aspects, the plasticizer will be selected from the group consisting of randomized cocoa butter, cocoa butter fractions, soft cocoa butters, and combinations thereof. Plasticizing ingredients may be added to the cocoa composition in an amount up to 10% by weight, excluding any emulsifiers. For example, plasticizers may be added in an amount of 0.5% to 10% by weight, 1% to 9 weight %, 1.5% to 8% by weight, 2% to 7% by weight, 3% to 6% by weight, 4% to 5% by weight. These amounts exclude any emulsifiers which will be considered a separate ingredient from the plasticizer ingredient.

Emulsifiers suitable for use in the cocoa compositions described herein will be well known to a person skilled in the art and may include, by way of example only, lecithin, polyglycerol polyricinoleate (PGPR) and/or variants thereof such as hydrolysed or PC-enriched (or phosphatidylcholine-enriched) lecithin. If used, emulsifiers will typically be used in an amount of less than 1%, less than 0.7%, or less than 0.5% by weight.

The cocoa compositions described herein can be produced by any conventional method for making cocoa-based compositions known to the skilled person. For example, to make a moldable cocoa composition, the non-fatty cocoa solids and other ingredients of the cocoa composition according to the invention are mixed, refined, and conched substantially in the same manner one would produce chocolate or cocoa-based confectionary compositions, using any methods known to those of skill in the art. Thus, the present invention includes a process of producing a cocoa composition comprising the steps of (a) mixing the ingredients as described herein, (b) refining the mixture of step a, (c) conching the refined mixture of step b, (d) optionally tempering the conched mixture of step c, and (e) recovering the finished cocoa composition. Once the cocoa composition is processed, it can be placed in molds, or otherwise formed or applied in and/or onto food products as is known in the art.

A cocoa composition described herein can be incorporated in or used to prepare any known edible material or other composition intended to be ingested and/or contacted with the mouth of a human or animal, such as, for example, pharmaceutical compositions, supplement compositions (e.g., gummy, tablet, etc.), edible gel mixes and compositions, dental and oral hygiene compositions, foodstuffs (e.g., confections, condiments, chewing gum, cereal compositions, baked goods, baking goods, cooking adjuvants, dairy products, and tabletop sweetener compositions), and beverage products (e.g., beverages, beverage mixes, beverage concentrates, etc.). Examples of such compositions and aspects thereof are set forth in PCT International Publication Nos. WO 2019/071220 and WO 2019/071182 and in US Patent Application Publication Nos. 2019/0223481 and 2019/0223483, each of which is incorporated by reference herein in its entirety.

The compositions described herein can be a beverage product or can be used to prepare a beverage product. As used herein a “beverage product” includes, but is not limited to, a ready-to-drink beverage, a beverage concentrate, a beverage syrup, frozen beverage, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts, smoothies and combinations thereof. Examples of frozen beverages include, but are not limited to, icees, frozen cocktails, daiquiris, pina coladas, margaritas, milk shakes, frozen coffees, frozen lemonades, granitas, and slushees. Beverages may be alcoholic (e.g., a liqueur or cream liqueur) or non-alcoholic beverages. The beverage may be a brewed for fermented beverage, for example, beer or kombucha. Beverage concentrates and beverage syrups can be prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water, liquid matrix, or aqueous solution.

In some aspects, a method of preparing a beverage provided herein includes adding a composition as described herein to a liquid matrix (e.g., water or an aqueous solution). The method can further comprise adding one or more sweeteners, additives and/or functional ingredients to the beverage or to the composition before adding it to the liquid matrix.

The compositions described herein can be a food product or can be used to prepare a food product. The food product may be any caloric or non-caloric food product suitable for human consumption. Suitable food products include, but are not limited to, confectionary products (e.g., candies, candied nuts, candy bars, caramels, chocolates, chocolate bars, chocolate drops, chocolate in the form of hollow figures or any desired shape, filled chocolate bars, pralines, truffles, cereal bars, chewing gum, and pastillage), condiments, chewing gum, cereal compositions, baked goods, bakery products (e.g., breads such as bagels, buns, rolls, biscuits and loaf breads; cookies; brownies; muffins; desserts such as cakes, cheesecakes and pies; snack cakes; sweet goods such as doughnuts, Danish, sweet rolls, cinnamon rolls and coffee cake), cooking adjuvants, dairy products (e.g., ice cream, yogurt, chilled desserts, pudding, mousse, custard, milk shakes, malts, cream cheeses, cheeses, fudge), dairy-alternatives, frozen desserts (e.g., ice cream, sorbet, frozen yoghurt, and the like), tabletop sweetener compositions, seasoning, sauces, gravies, soups, dressings, snack products (e.g., granola bars, nutrition bars, and the like), and the like. The cocoa compositions described herein may able may be used in food products in any form, such as melted or mixed into the recipe of the end product, in the form of a filling, inclusions, toppings, or coatings, molded around other discrete ingredients such as nuts, fruit, dried fruit, biscuits, candy pieces or shapes, combinations thereof, and the like. In frozen desert compositions, the cocoa composition may be used as a coating, inclusion (chunks, flakes, or ripples), topping, or core (soft or solid).

### Sensory Modifier

A sensory modifier is a compound or composition that in certain amounts changes the sensory characteristics or sensory attributes of a consumable, e.g., a beverage, a food product, etc. Non-limiting examples of sensory characteristics that a sensory modifier can change include bitterness, sourness, numbness, astringency, metallic notes, cloyingness, dryness, sweetness, starchiness, mouthfeel, temporal aspects of sweetness, temporal aspects of saltiness, temporal aspects of bitterness, or temporal aspects of any sensory characteristic described herein, as well as flavor notes, such as licorice, vanilla, prune, cotton candy, lactic, umami, pulse, and molasses flavor notes. The sensory modifier may enhance a sensory characteristic, such as enhancing flavor profile; may suppress a sensory characteristic, such as reducing bitterness and reducing cooked milk flavor; or may change the temporal aspects of a sensory characteristic. In some aspects, the amount of sensory modifier employed in a reduced sugar cocoa composition alters at least one sensory characteristic, e.g., the combination may have reduced bitterness, reduced cooked milk favor, increased cocoa flavor, and/or increased cream flavor compared to the reduced sugar cocoa compositions without the sensory modifier.

The present disclosure provides a sensory modifier comprising one or more caffeoyl-substituted quinic acids, and salts thereof. In various aspects, the caffeoyl-substituted quinic acids comprise an ester derived from the carboxylic acid of caffeic acid and an alcohol of quinic acid. A “caffeoyl-substituted quinic acid” or “caffeoylquinic acid” as the terms are used herein, include monocaffeoylquinic acids and dicaffeoylquinic acids and salts thereof. Monocaffeoylquinic acids comprise an ester derived from a single caffeic acid and a quinic acid (e.g., chlorogenic acid (5-O-caffeoylquinic acid), neochlorogenic acid (3-O-caffeoylquinic acid), and cryptochlorogenic acid (4-O-caffeoylquinic acid)). Dicaffeoylquinic acids comprise an ester derived from two caffeic acids and a quinic acid (e.g., 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid)). Thus, the sensory modifier includes both acid forms and salt forms of caffeoyl-substituted quinic acids. Free acid forms of various caffeoyl-substituted quinic acids are shown in Table 1.

TABLE 1
Structures of various caffeoyl-substituted quinic acids.

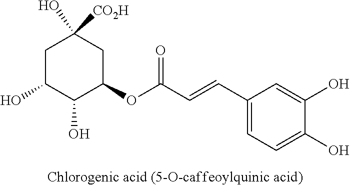 [SMILES: O=C(/C=C/c1ccc(O)c(O)c1)O[C@@H]1C[C@](O)(C(=O)O)C[C@@H](O)[C@H]1O]

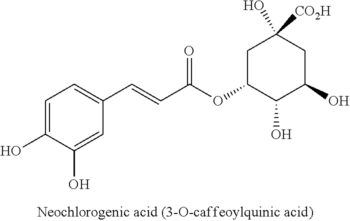 [SMILES: O=C(/C=C/c1ccc(O)c(O)c1)O[C@@H]1C[C@@](O)(C(=O)O)C[C@@H](O)[C@@H]1O]

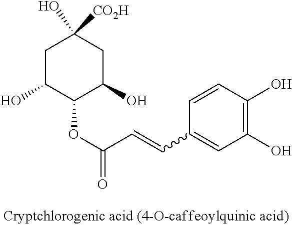 [SMILES: O=C(C=Cc1ccc(O)c(O)c1)O[C@H]1[C@H](O)C[C@](O)(C(=O)O)C[C@H]1O]

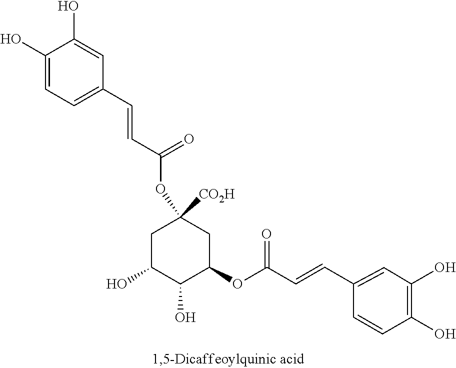 [SMILES: O=C(/C=C/c1ccc(O)c(O)c1)O[C@@H]1C[C@](OC(=O)/C=C/c2ccc(O)c(O)c2)(C(=O)O)C[C@@H](O)[C@H]1O]

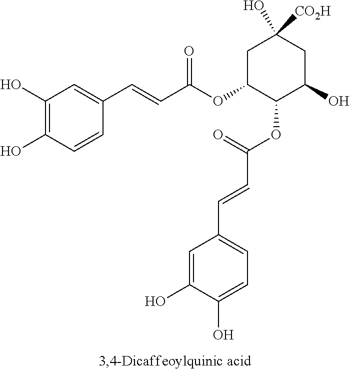 [SMILES: O=C(/C=C/c1ccc(O)c(O)c1)O[C@H]1[C@H](O)C[C@](O)(C(=O)O)C[C@H]1OC(=O)/C=C/c1ccc(O)c(O)c1]

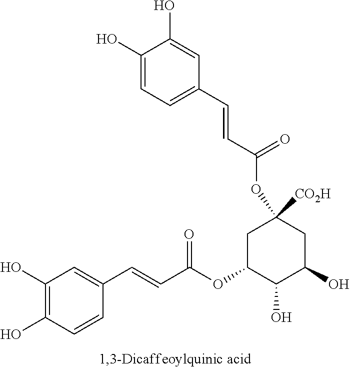 [SMILES: O=C(/C=C/c1ccc(O)c(O)c1)O[C@@H]1C[C@@](OC(=O)/C=C/c2ccc(O)c(O)c2)(C(=O)O)C[C@@H](O)[C@@H]1O]

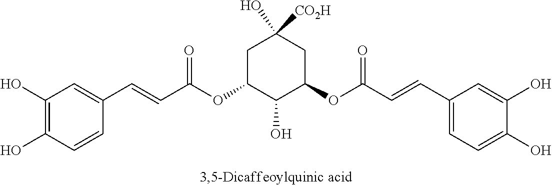 [SMILES: O=C(/C=C/c1ccc(O)c(O)c1)O[C@@H]1C[C@](O)(C(=O)O)C[C@@H](OC(=O)/C=C/c2ccc(O)c(O)c2)[C@H]1O]

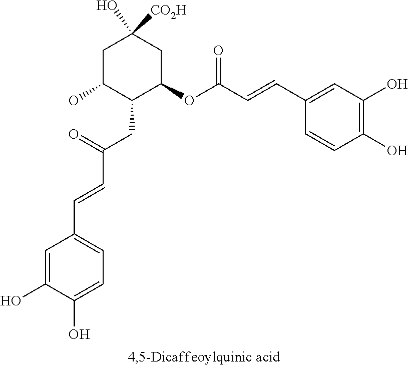 [SMILES: O=C(/C=C/c1ccc(O)c(O)c1)C[C@@H]1[C@H](O)C[C@@](O)(C(=O)O)C[C@H]1OC(=O)/C=C/c1ccc(O)c(O)c1]

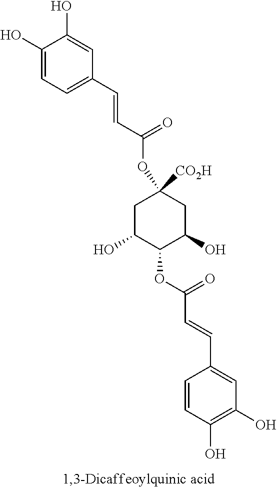 [SMILES: O=C(/C=C/c1ccc(O)c(O)c1)O[C@H]1[C@H](O)C[C@](OC(=O)/C=C/c2ccc(O)c(O)c2)(C(=O)O)C[C@H]1O]

In various aspects, the sensory modifier further comprises one or more of quinic acid, caffeic acid, ferulic acid, sinapic acid, p-coumaric acid, an ester of quinic acid, an ester of caffeic acid, an ester of ferulic acid, an ester of sinapic acid, an ester of p-coumaric acid, an ester of caffeic acid and quinic acid, an ester of caffeic acid and quinic acid comprising a single caffeic acid moiety, an ester of caffeic acid and quinic acid comprising more than one caffeic acid moiety, an ester of ferulic acid and quinic acid, an ester of ferulic acid and quinic acid comprising a single ferulic acid moiety, an ester of ferulic acid and quinic acid comprising more than one ferulic acid moiety, an ester of sinapic acid and quinic acid, an ester of sinapic acid and quinic acid comprising a single sinapic acid moiety, an ester of sinapic acid and quinic acid comprising more than one sinapic acid moiety, an ester of p-coumaric acid and quinic acid, an ester of p-coumaric acid and quinic acid comprising a single p-coumaric acid moiety, an ester of p-coumaric acid and quinic acid comprising more than one p-coumaric acid moiety, a di-ester of quinic acid containing one caffeic acid moiety and one ferulic acid moiety, a caffeic ester of 3-(3,4-dihydroxyphenyl)lactic acid, a caffeic acid ester of tartaric acid, a caffeic acid ester of tartaric acid containing more than one caffeic acid moieties, and/or isomers thereof, and the corresponding salts.

In some aspects, the sensory modifier comprises one or more of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, rosmarinic acid, caftaric acid (monocaffeoyltartaric acid), cichoric acid (dicaffeoyltartaric acid) and salts, and/or isomers thereof, and the corresponding salts.

In some aspects, the sensory modifier consists essentially of one or more compounds selected from the list consisting of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and any combination thereof, isomers thereof, and the corresponding salts. In various aspects, one or more alcohol of the caffeoyl moiety is replaced with a hydrogen or substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso-feruloyl, sinapoyl, galloyl, sulfate, phosphate, or phosphonate. Thus, modified and substituted caffeic acid moieties result in a cinnamic acid, o-coumaroyl, p-coumaric acid, m-coumaric acid, ferulic acid, and the acyl and ester forms thereof. In various aspects, one or more alcohol of the quinic acid moiety is substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso-feruloyl, sinapoyl, galloyl, sulfate, phosphate, or phosphonate.

The sensory modifier can include one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Examples of a ferulic ester of quinic acid includes 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, and combinations thereof. An example of a caffeic ester of 3-(3,4-dihydroxyphenyl)lactic acid is rosmarinic acid. Examples of a caffeic acid ester of tartaric acid includes cichoric acid (dicaffeoyltartaric acid) and caftaric acid (monocaffeoyltartaric acid) and combinations thereof.

In an alternative aspect, the sensory modifier is a mixture consisting of one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Such sensory modifier also includes salts thereof so as to have a salt fraction and an acid fraction. It is thus further envisaged that each of the various aspects described herein related to caffeoylquinic acid and other sensory modifiers can be equally applicable to this alternative.

Caffeic acid has the structure:

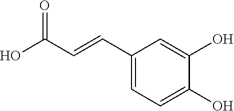 [SMILES: O=C(O)/C=C/c1ccc(O)c(O)c1]

Quinic acid has the structure:

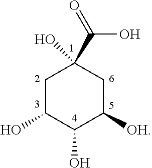 [SMILES: O=C(O)[C@]1(O)C[C@@H](O)[C@@H](O)[C@H](O)C1]

The structure provided above is D-(−)-quinic acid and the numbers shown correspond to current IUPAC numbering.

In various aspects, the sensory modifier can be enriched for one or more of caffeic acid, monocaffeoylquinic acids, and dicaffeoylquinic acids. The term “enriched” refers to an increase in an amount of one of caffeic acid, monocaffeoylquinic acids, and dicaffeoylquinic acids relative to one or more other compounds that are present in the sensory modifier. A sensory modifier that is enriched for one or more of caffeic acid, monocaffeoylquinic acids, and dicaffeoylquinic acids can modify the sensory attributes of the salt composition.

The sensory modifier enriched for one or more dicaffeoylquinic acids can modify the sensory attributes of a salt composition. A sensory modifier that is enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more dicaffeoylquinic acids as a percentage of the total weight of the sensory modifier.

In various aspects, at least or about 10 wt %, 15 wt %, 20 wt %, 25 wt %, 30 wt %, 35 wt %, 40 wt %, 45 wt %, or at least or about 50 wt % of the total sensory modifier can be monocaffeoylquinic acids and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be chlorogenic acid (5-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be neochlorogenic acid (3-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be cryptochlorogenic acid (4-O-caffeoylquinic acid) and salts thereof.

In various further aspects, at least or about 10 wt %, 15 wt %, 20 wt %, 25 wt %, 30 wt %, 35 wt %, 40 wt %, 45 wt %, or at least or about 50 wt % of the total sensory modifier can be 1,3-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 4,5-dicaffeoylquinic acid and salts thereof.

The sensory modifier can, for example, have a weight ratio of total monocaffeoylquinic acids and salts to total dicaffeoylquinic acids and salts of 20:1 to 1:20, e.g., from 3:1 to 1:20. In various aspects, the sensory modifier has a weight ratio from 15:1 to 1:15, from 10:1 to 1:10, from 5:1 to 1:5, from 3:1 to 1:3, from 2:1 to 1:2, from 1.5:1 to 1:1.5, from 5:1 to 1:1, from 3:1 to 1:1, from 2:1 to 1:1, from 1.5:1 to 1:1.1, from 1:1 to 1:20, from 1:1 to 1:15, from 1:1 to 1:10, from 1:5 to 1:20, from 1:5 to 1:15, from 1:5 to 1:10, from 1:2 to 1:20, from 1:2 to 1:15, from 1:2 to 1:10, from 1:2 to 1:5, from 1:1 to 1:3, from 1:1 to 1:2, or from 1:1 to 1:1.5 monocaffeoylquinic acid and salts thereof:dicaffeoylquinic acids and salts thereof. In some aspects, the sensory modifier has a greater amount, by weight, of dicaffeoylquinic acids and salts of dicaffeoylquinic acids compared to the amount of monocaffeoylquinic acids and salts of monocaffeoylquinic acids. In various aspects, the sensory modifier has a ratio of about 1:1 of monocaffeoylquinic acid:dicaffeoylquinic acids, including salts thereof.

The sensory modifier provided herein may contain a portion that is in salt form (corresponding to a “salt fraction”) and a portion that is in acid form (corresponding to an “acid fraction”). In various aspects, the salt fraction accounts for at least 50 wt % of the total sensory modifier. In various aspects, the sensory modifier comprises a salt fraction and an acid fraction, wherein the salt fraction comprises one or more of a salt of a monocaffeoylquinic acid and a salt of a dicaffeoylquinic acid, wherein the acid fraction comprises one or more of a monocaffeoylquinic acid and a dicaffeoylquinic acid, and wherein the salt fraction comprises at least 50 wt % of the total sensory modifier.

For example, the salt fraction comprises at least or about 50 wt %, 55 wt %, 60 wt %, 65 wt %, 70 wt %, 75 wt %, 80 wt %, 85 wt %, or at least or about 90 wt % of the total sensory modifier. In further aspects, the salt fraction comprises less than or about 60 wt %, 65 wt %, 70 wt %, 75 wt %, 80 wt %, 85 wt %, or less than or about 90 wt % of the total sensory modifier. In yet further aspects, the salt fraction comprises 50 wt % to 90 wt %, 50 wt % to 80 wt %, 50 wt % to 75 wt %, 60 wt % to 90 wt %, 60 wt % to 80 wt %, 65 wt % to 80 wt %, or 65 wt % to 75 wt % of the total sensory modifier. Unless otherwise specified the wt % of the salt fraction should be calculated inclusive of the balancing cation species.

In further examples, the acid fraction comprises at least or about 5 wt %, 10 wt %, 15 wt %, 20 wt %, 25 wt %, 30 wt %, 35 wt %, 40 wt %, or at least or about 45 wt % of the total sensory modifier. In further aspects, the acid fraction comprises less than or about 10 wt %, 15 wt %, 20 wt %, 25 wt %, 30 wt %, 35 wt %, 40 wt %, or less than about 50 wt % of the total sensory modifier. In yet further aspects, the acid fraction comprises 5 wt % to 50 wt %, 10 wt % to 50 wt %, 15 wt % to 50 wt %, 20 wt % to 50 wt %, 5 wt % to 40 wt %, 10 wt % to 40 wt %, 15 wt % to 40 wt %, 20 wt % to 40 wt %, 5 wt % to 35 wt %, 10 wt % to 35 wt %, 15 wt % to 35 wt %, 20 wt % to 35 wt %, 5 wt % to 30 wt %, 10 wt % to 30 wt %, 15 wt % to 30 wt %, 20 wt % to 30 wt %, 5 wt % to 20 wt %, 10 wt % to 20 wt %, 15 wt % to 20 wt %, 5 wt % to 15 wt %, 10 wt % to 15 wt %, or 5 wt % to 10 wt % of the total sensory modifier.

In various aspects, e.g., in an aqueous solution, the salt form of the total sensory modifier exists in equilibrium with the acid form. For example, a particular salt form molecule can become protonated and thus convert into the acid form and an acid form molecule can become deprotonated to result in a salt form. After approaching or achieving equilibrium, such interplay will not substantially alter the overall wt % of a given form or fraction of the total sensory modifier. For example, a composition having a salt fraction of 50 wt % or more of the total sensory modifier can maintain the same proportions of salt and acid fractions even though the various compounds might exchange from one fraction to another.

There are also cases where the equilibrium between salt and acids forms can shift in response to the addition of components to the composition. For example, addition of buffer solution, salts, acid, or base can shift the equilibrium to favor the salt or acid fraction, and thus alter the wt % of the composition.

In various other aspects, e.g., in a solid composition, the salt form and acid forms can be in a solid state, in which the proportion between salt and acid forms is frozen. It should be understood that, in various aspects, the ratio of the salt fraction to acid fraction in a solid composition, such as a granulated salt composition, can differ from that of a resulting solution to which the solid composition is added. For example, in some aspects, a solid state salt composition will, upon dissolving or disintegrating, result in a solution having a sensory modifier of which at least 50 wt % is in salt form.

### Effective Amount of Sensory Modifier

The compositions of the present disclosure comprise a sensory modifier in an amount effective to reduced bitterness, improve sweetness temporal attributes, reduce cooked milk flavor, increase cocoa flavor, and/or increase cream flavor of the cocoa composition.

As used herein, “taste” refers to sensory perception on the tongue. For example, the 5 basic tastes are sweet, sour, salty, bitter, and umami.

As used herein, “aroma” refers to the orthonasal perception in the nasal cavity.

As used herein, “flavor” refers to the taste and retronasal perception in the nasal cavity.

As used herein, “off-taste(s)” refer to a taste or flavor attribute profile that is not characteristic or usually associated with a substance or composition as described herein and/or a characteristic taste or flavor associated with a substance or composition that is undesirable. For example, the off-taste may be an undesirable taste such as bitterness, undesirable mouthfeel such as astringency, mouth drying, undesirable flavor such as rancid, cardboard, aftertaste, inconsistent flavor (e.g., a flavor with an uneven onset or intensity, a flavor that may be perceived too early or too late), and the like.

As used herein, “cocoa flavor” refers to the aroma or flavor attribute profile associated with unsweetened, pure cocoa powder (non-alkalized). For example, the cocoa flavor may be a flavor characterized as chocolate, roasted, coffee notes, or combinations thereof.

As used herein, “cooked milk flavor” refers to the aroma or flavor attribute profile associated with evaporated milk, ultra-high temperature processed milk, or powdered milk.

As used herein, “cream flavor” refers to the rich, fatty, and creamy aroma or flavor attribute profile associated with half & half or heavy whipping cream.

A sensory panel can be used to determine the magnitude of, for example, reduction in bitterness or shifts in its temporal profile, thereby quantifying the amount of sensory modifier effective to reduce said bitterness. Sensory panels are a scientific and reproducible method that is essential to the food and beverage industry. A sensory panel involves a group of two or more individual panelists. Panelists are instructed according to industry-recognized practices to avoid the influence of personal subjectivity and strengthen reproducibility. For example, panelists may objectively evaluate sensory attributes of a tested product but may not provide subjective attributes such as personal preference. In various aspects, the sensory panel can be conducted with two, three, four, five, six, or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e., 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 15, where 0 corresponds to the absence of the attribute, while 6, 9, or 15, respectively, corresponds to the upper bound extreme occurrence of the attribute. The panel may use a roundtable consensus approach, or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g., saltiness, sourness, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

As used herein, “roundtable consensus approach” refers to the sensory panel assay methodology wherein panelists discus sensory attributes and intensities before mutually agreeing on an intensity score and attribute characterization for the particular sensory attribute(s) being assayed. A sensory panel using a roundtable consensus approach may include 2, 3, 4, 5, 6, or more panelists. Consensus intensity scales can range from 0 to 6 (i.e., 0=not detected, 1=trace, 2=slight, 3=moderate, 4=definite, 5=strong, 6=extreme) or 0 to 9 (i.e., 0=not detected, 1=trace, 2=faint, 3=slight, 4=mild, 5=moderate, 6=definite, 7=strong, 8=very strong, 9=extreme). For a given set of samples, the panelists will identify and agree on a lexicon of sensory attribute, including, if applicable, reference or standardized samples (also referred to as sensory anchors) for a particular sensory attribute. The reference sample(s) used for a given sensory attribute(s) will depend on the samples being assayed and the lexicon of sensory attributes determined by the panel. One of skill in the art will recognize the appropriate lexicon and reference or standard samples necessary for sensory assessment of a given sample(s).

In some aspects, the samples are scored and evaluated by panelists independently after panelists have agreed upon or been instructed in a lexicon of sensory attributes and intensity scores including, if applicable, assay specific calibration on reference samples (also referred to as sensory anchors) for a particular sensory attribute. Examples of common reference samples are described below. Panelists may evaluate samples in replicate and may be blinded to the samples they are testing. Samples being tested may be provided to the panelists randomly or in a sequential order. In some aspects, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

As used herein, “randomized balanced sequential order” refers to the order in which samples are presented in which the order is randomized but across all panelists all possible orders of the samples will be presented to remove bias for the samples being tested in a particular order. For example, for a randomized balanced sequential order of two samples, there would be an equal likelihood that a given panelist receives sample 1 before sample 2 and sample 2 before sample 1. In an example with three samples (i.e., samples 1, 2, and 3), a randomized balanced sequential order would include an equal likelihood that panelists receiving samples in the following orders: (i) 1, 2, 3; (ii) 1, 3, 2; (iii) 2, 1, 3; (iv) 2, 3, 1; (v) 3, 2, 1; (vi) 3, 1, 2.

A sensory attribute(s) of a given composition may be evaluated in comparison to one or more reference or anchor samples. For example, sodium chloride solutions can be used by experienced panelists as saltiness anchors to assess the relative intensity of saltiness for a given composition; sucrose solutions can be used by experienced panelists as sweetness anchors to assess the relative intensity of sweetness for a given composition; citric acid solutions can be used by experienced panelists as sourness anchors to assess the relative intensity of sourness for a given composition; caffeine solutions can be used by experienced panelists as bitterness anchors to assess the relative intensity of bitterness for a given composition; and monosodium glutamate (MSG) solutions can be used by experienced panelists as umami anchors to assess the relative intensity of umami for a given composition. Experienced panelists can be presented with a solution to assess sensory attributes, e.g., 10-20 mL of a sample. Panelists will dispense approximately 3-4 mL of each solution into their own mouths, disperse the solution by moving their tongues, and record a value for the particular sensory attribute being tested. If multiple solutions are to be tested in a session, the panelists may cleanse their palates with water between samples. For example, a roundtable assessment of saltiness, sweetness, sourness, umami, and the like can assign a scale of 0 to 9 with, e.g., a score of 0 indicating no saltiness and a score of 9 indicating extreme saltiness (0=not detected, 1=trace, 2=faint, 3=slight, 4=mild, 5=moderate, 6=definite, 7=strong, 8=very strong, 9=extreme). Equivalent scales and methodologies can be used for sweet, bitter, sour, and umami sensory attributes.

As a further example, saltiness of a composition can be tested by a panel of at least two panelists. The panelists can use a standard range of 0.18% (wt), 0.2% (wt), 0.35% (wt), 0.5% (wt), 0.567% (wt), 0.6% (wt), 0.65% (wt), and 0.7% (wt) sodium chloride solutions in water corresponding to a saltiness intensity value of 2, 2.5, 5, 8.5, 10, 11, 13, and 15, respectively. A skilled artisan will recognize that depending on the sample/composition being tested, the number and range of standard solutions may be changed (e.g., using only the solutions corresponding to the 2, 2.5, and 5 saltiness intensity values). For each test composition, the panelists dispense approximately 2-5 mL, for liquid compositions or solutions prepared with water, or 5-10 g, for solid compositions, of each composition into their own mouths, disperses the composition by moving their tongues/chewing, and records a saltiness intensity value between 0 and 15 for each composition based on comparison to the aforementioned standard sodium chloride solutions. Between tasting compositions, the panelists are able to cleanse their palates with water. The panelists also can taste the standard 0.18%, 0.2%, 0.35%, 0.5%, 0.567%, 0.6%, 0.65%, and 0.7% sodium chloride solutions ad libitum between tasting test solutions to ensure recorded saltiness intensity values are accurate against the scale of the standard sodium chloride solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Saltiness Intensity Test.”

Sourness of a composition can be tested by a panel of at least two panelists. The panelists can use a standard range of 0.035% (wt), 0.05% (wt), 0.07% (wt), 0.15% (wt), and 0.2% (wt) citric acid solutions in water corresponding to a sourness intensity value of 2, 3, 5, 10, and 15, respectively. A skilled artisan will recognize that depending on the sample/composition being tested, the number and range of standard solutions may be changed (e.g., using only the solutions corresponding to the 2 and 7 sourness intensity values). For each test composition, the panelists dispense approximately 2-5 mL, for liquid compositions or solutions prepared with water, or 5-10 g, for solid compositions, of each composition into their own mouths, disperses the composition by moving their tongues/chewing, and records a sourness intensity value between 0 and 15 for each composition based on comparison to the aforementioned standard citric acid solutions. Between tasting compositions, the panelists are able to cleanse their palates with water. The panelists also can taste the standard 0.035%, 0.05%, 0.07%, 0.15%, and 0.2% citric acid solutions ad libitum between tasting test solutions to ensure recorded sourness intensity values are accurate against the scale of the standard citric acid solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sourness Intensity Test.”

Bitterness of a composition can be tested by a panel of at least two panelists. The panelists can use a standard range of 0.0125% (wt), 0.01875% (wt), 0.025% (wt), 0.031% (wt), 0.07% (wt), and 0.12% (wt) caffeine solutions in water corresponding to a bitterness intensity value of 2, 3, 4, 5, 10, and 15, respectively. A skilled artisan will recognize that depending on the sample/composition being tested, the number and range of standard solutions may be changed (e.g., using only the solutions corresponding to the 2, 3, and 5 bitterness intensity values). For each test composition, the panelists dispense approximately 2-5 mL, for liquid compositions or solutions prepared with water, or 5-10 g, for solid compositions, of each composition into their own mouths, disperses the composition by moving their tongues/chewing, and records a bitterness intensity value between 0 and 15 for each composition based on comparison to the aforementioned standard caffeine solutions. Between tasting compositions, the panelists are able to cleanse their palates with water. The panelists also can taste the standard 0.0125%, 0.01875%, 0.025%, 0.031%, 0.07%, and 0.12% caffeine solutions ad libitum between tasting test solutions to ensure recorded bitterness intensity values are accurate against the scale of the standard caffeine solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Bitterness Intensity Test.”

Sweetness of a composition can be tested by a panel of at least two panelists. The panelists can use a standard range of 2% (wt), 5% (wt), 8% (wt), 10% (wt), and 15% (wt) sucrose solutions corresponding to a sweetness intensity value of 2, 5, 8, 10, and 15, respectively. A skilled artisan will recognize that depending on the sample/composition being tested, the number and range of standard solutions may be changed (e.g., using only the solutions corresponding to the 2, 5, and 8 sweetness intensity values). For each test composition, the panelists dispense approximately 2-5 mL, for liquid compositions or solutions prepared with water, or 5-10 g, for solid compositions, of each composition into their own mouths, disperses the composition by moving their tongues/chewing, and records a sweetness intensity value between 0 and 15 for each composition based on comparison to the aforementioned standard sucrose solutions. Between tasting compositions, the panelists are able to cleanse their palates with water. The panelists also can taste the standard 2%, 5%, 8%, 10%, and 15% sucrose solutions ad libitum between tasting test solutions to ensure recorded sweetness intensity values are accurate against the scale of the standard sucrose solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sweetness Intensity Test.”

Umami of a composition can be tested by a panel of at least two panelists. The panelists can use a standard range of 0.75% (wt) and 0.125% (wt) monosodium glutamate (MSG) solutions corresponding to an umami intensity value of 4 and 6.5, respectively. A skilled artisan will recognize that depending on the sample/composition being tested, the number and range of standard solutions may be changed (e.g., adding additional umami solutions if the umami intensity is expected to be appreciably outside of the umami intensity value of 4-6.5). For each test composition, the panelists dispense approximately 2-5 mL, for liquid compositions or solutions prepared with water, or 5-10 g, for solid compositions, of each composition into their own mouths, disperses the composition by moving their tongues/chewing, and records an umami intensity value between 0 and 15 for each composition based on comparison to the aforementioned standard MSG solutions. Between tasting compositions, the panelists are able to cleanse their palates with water. The panelists also can taste the standard 0.075% and 0.125% MSG solutions ad libitum between tasting test solutions to ensure recorded umami intensity values are accurate against the scale of the standard MSG solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Umami Intensity Test.”

A control sample is typically used as a reference point or for comparison purposes. For example, a control sample can be used to qualify the effectiveness of a sensory modifier. The control sample can be a composition such as a composition as described herein, but without the presence of the sensory modifier. Other than the sensory modifier, the control sample is otherwise the same, and it should contain the same component(s) and other ingredients at the same relative concentrations. Other standard samples are commonly used in sensory panels, for example standard samples used to evaluate intensity of sensory attributes as outlined above. In other aspects, the control sample may be a modified control sample which contains a different sensory modifier such as a competitor sensory modifier.

This disclosure is not limited to sensory testing by experienced or trained panelists. For example, it is possible to utilize untrained and inexperienced panelists. However, in the case of untrained and inexperienced panelists, a greater number of these panelists is usually necessary to provide reproducible results, which will typically focus on subjective attributes such as preference or overall liking. Similarly, untrained, and inexperienced panelists may be asked to evaluate relative changes in a given sensory attribute between two samples. For example, if a particular sample is more or less salty, more or less sweet, more or less bitter, etc., than a reference sample.

An exemplified sensory assay and test criteria for further sensory attributes are described in the Examples provided in this disclosure.

In some aspects, the amount of sensory modifier effective to decrease bitterness can be the amount effective to reduce bitterness intensity by at least 0.5, 1, 1.5, 2, or at least 2.5 units relative to bitterness intensity in an equivalent composition lacking the sensory modifier. The bitterness intensity score is determined by at least three panelists trained in tasting bitter compositions using a roundtable methodology using a scale of 0 to 9, where a score of 0 indicates no bitterness and 9 indicates extreme bitterness intensity (i.e., 0=not detected, 1=trace, 2=faint, 3=slight, 4=mild, 5=moderate, 6=definite, 7=strong, 8=very strong, 9=extreme). In some aspects, the bitterness may be reduced by at least 2, at least 3, or at least 4 units. Similar evaluation processes may be used to score other sensory attributes of the composition described herein.

In some aspects, the amount of sensory modifier effective to decrease bitterness can be the amount effective to reduce bitterness intensity score by at least 0.5, 1, 1.5, 2, or at least 2.5 units relative to bitterness intensity in an equivalent composition lacking the sensory modifier. The bitterness intensity score may be determined as the average bitterness intensity score from at least seven panelists, trained in sensory evaluation, upon randomized balanced sequential order evaluation of samples using a scale of 0 to 15, where a score of 0 indicates no bitterness and 15 indicates extreme bitterness intensity. In some aspects, the bitterness may be reduced by at least 2, at least 3, at least 4 units, at least 5, at least 6, at least 7, or more units.

The compositions described herein can have various amounts of sensory modifier. For example, the compositions described herein may include steviol glycosides and the sensory modifier in a ratio between 1:0.3 and 1:3, between 1:0.5 and 1:2, or between 1:0.75 and 1:1.5. For example, the steviol glycosides and sensory modifier may be in a ratio of about 1:1.

The sensory modifier can be present in the composition in any amount desired for the particular use. For example, the sensory modifier can be present in a cocoa composition at a total concentration from 0.001% (wt) to from 0.001% (wt) to 1.0% (wt), 0.001% (wt) to 0.5% (wt), 0.005% (wt) to 0.1% (wt), 0.005% (wt) to 0.075% (wt), or 0.005% (wt) to 0.05% (wt). The cocoa composition may include at least 0.001%, 0.002%, 0.005%, 0.01%, 0.02%, or 0.05% by weight of the sensory modifier. The cocoa composition may include the sensory modifier at a concentration up to 1.0% (wt), 0.5% (wt), 0.25% (wt), 0.2% (wt), 0.1% (wt), or 0.05% (wt).

The sensory modifier can be present in the cocoa composition at a total concentration such that when used in the preparation of a food or beverage product, the resulting food or beverage product includes from 0.001% (wt) to 1.0% (wt), 0.001% (wt) to 0.5% (wt), 0.005% (wt) to 0.1% (wt), 0.005% (wt) to 0.050% (wt), or 0.005% (wt) to 0.02% (wt) of the sensory modifier. The composition may include the sensory modifier at a concentration such that a food or beverage product made therefrom contains of at least 0.001%, 0.002%, 0.005%, 0.01%, 0.02%, or 0.05% by weight of the sensory modifier. The composition may include the sensory modifier at a concentration such that a food or beverage product prepared therefrom contains up to 1.0% (wt), 0.5% (wt), 0.25% (wt), 0.2% (wt), 0.1% (wt), or 0.05% (wt) of the sensory modifier. For example, the sensory modifier can be present in a cocoa composition at a total concentration from about 0.1% (wt) to about 75.0% (wt), from about 0.5% (wt) to about 50.0% (wt), or from about 1.0% (wt) to about 25.0% (wt). In some aspects, the sensory modifier can be present in a cocoa composition at a total concentration of at least 0.5%, 1.0%, 1.5%, 2.0%, 3.0%, 4.0%, 5.0%, 6.0%, 7.0%, 8.0%, 9.0%, or at least 10% by weight of the composition.

The cocoa composition can comprise an amount of sensory modifier such that, when the cocoa composition is used in the preparation of a food or beverage product, the sensory modifier is present in the food or beverage product in an amount desired for a particular use. For example, sensory modifier can be present in the food or beverage product at a total concentration from about 1 ppm to about 1000 ppm, or from about 1 ppm to about 2000 ppm. In some aspects, sensory modifier can be present in the food or beverage product at a total concentration from about 100 ppm to about 2000 ppm, about 200 ppm to about 2000 ppm, 300 ppm to about 2000 ppm, 400 ppm to about 2000 ppm, 500 ppm to about 2000 ppm, 600 ppm to about 2000 ppm, 700 ppm to about 2000 ppm, 800 ppm to about 2000 ppm, 900 ppm to about 2000 ppm, or 1000 ppm to about 2000 ppm. In some aspects, sensory modifier can be present in the food or beverage product at a total concentration of or greater than about 10, 100, 200, 300, 400, 500, 600, 700, 800, 900, 1000, 110, 1200, 1300, 1400, 1500, 1600, 1700, 1800, 1900, or 2000 ppm. In various aspects, the sensory modifier can be present in the food or beverage product at a total concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, or 900 ppm to about 1000 ppm. In some aspects, sensory modifier can be present in the food or beverage product at a total concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, sensory modifier can be present in the food or beverage product at a total concentration from about 400 ppm to about 800 ppm.

The amount of an individual sensory modifier species in the various compositions described herewith can each independently vary. For example, monocaffeoylquinic acid, dicaffeoylquinic acid, or both, can each individually be present in the composition at a concentration from about 1 ppm to about 1000 ppm. In some aspects, monocaffeoylquinic acid, dicaffeoylquinic acid, or both, can each individually be present in the composition at a concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, 900 ppm to about 1000 ppm. In some aspects, monocaffeoylquinic acid, dicaffeoylquinic acid, or both, can each individually be present at a concentration of or greater than about 10, 50, 100, 200, 300, 400, 500, 600, 700, 800, 900, or 1000 ppm in the cocoa composition. In some aspects, monocaffeoylquinic acid, dicaffeoylquinic acid, or both, can each individually be present in the cocoa composition at a concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, monocaffeoylquinic acid, dicaffeoylquinic acid, or both, can each individually be present in the cocoa composition at a concentration from about 400 ppm to about 800 ppm.

### Botanical Source of Sensory Modifier

In various aspects, the sensory modifier can be isolated from botanical sources. Various botanical sources comprise sensory modifiers and sensory modifiers can be isolated from these botanical sources. Some examples of botanical sources from which sensory modifiers can be isolated include Eucommia ulmoides, honeysuckle, Nicotiana benthamiana, artichoke, globe artichoke, cardoon, Stevia rebaudiana, monkfruit, coffee, coffee beans, green coffee beans, tea, white tea, yellow tea, green tea, oolong tea, black tea, red tea, post-fermented tea, bamboo, heather, sunflower, blueberries, cranberries, bilberries, grouseberries, whortleberry, lingonberry, cowberry, huckleberry, grapes, chicory, eastern purple coneflower, echinacea, Eastern pellitory-of-the-wall, Upright pellitory, Lichwort, Greater celandine, Tetterwort, Nipplewort, Swallowwort, Bloodroot, Common nettle, Stinging nettle, Potato, Potato leaves, Eggplant, Aubergine, Tomato, Cherry tomato, Bitter apple, Thorn apple, Sweet potato, apple, Peach, Nectarine, Cherry, Sour cherry, Wild cherry, Apricot, Almond, Plum, Prune, Holly, Yerba mate, Mate, Guayusa, Yaupon Holly, Kuding, Guarana, Cocoa, Cocoa bean, Cacao, Cacao bean, Kola nut, Kola tree, Cola nut, Cola tree, Ostrich fern, Oriental ostrich fern, Fiddlehead fern, Shuttlecock fern, Oriental ostrich fern, Asian royal fern, Royal fern, Bracken, Brake, Common bracken, Eagle fern, Eastern brakenfern, Clove, Cinnamon, Indian bay leaf, Nutmeg, Bay laurel, Bay leaf, Basil, Great basil, Saint-Joseph's-wort, Thyme, Sage, Garden sage, Common sage, Culinary sage, Rosemary, Oregano, Wild marjoram, Marjoram, Sweet marjoram, Knotted marjoram, Pot marjoram, Dill, Anise, Star anise, Fennel, Florence fennel, Tarragon, Estragon, Mugwort, Licorice, Liquorice, Soy, Soybean, Soyabean, Soya vean, Wheat, Common wheat, Rice, Canola, Broccoli, Cauliflower, Cabbage, Bok choy, Kale, Collard greens, Brussels sprouts, Kohlrabi, Winter's bark, Elderflower, Assa-Peixe, Greater burdock, Valerian, and Chamomile.

Some botanical sources may produce sensory modifiers that are enriched for one or more of caffeic acid, monocaffeoylquinic acids, and dicaffeoylquinic acids. For example, sensory modifiers isolated from yerba mate plant (Ilex paraguariensis) are enriched for monocaffeoylquinic and dicaffeoylquinic acids. In other aspects, sensory modifiers isolated from yerba mate plant that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic, 3,5-dicaffeoylquinic acid, and 4,5-dicaffeoylquinic acid, and salts thereof. For example, sensory modifiers isolated from other botanical sources can be enriched for dicaffeoylquinic acids. In other aspects, sensory modifiers isolated from other botanical sources that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and salts thereof.

Sensory modifier may be isolated in a variety of ways. Some suitable processes are disclosed in more detail in U.S. application Ser. No. 16/373,206, filed Apr. 4, 2019 and entitled “Steviol Glycoside Solubility Enhancers,” which was published on Jul. 25, 2019 as US Patent Application Publication No. 2019/0223481; International Application No. PCT/US2018/054691, filed Oct. 5, 2018 and entitled “Steviol Glycoside Solubility Enhancers;” U.S. Provisional Application No. 62/569,279, filed Oct. 6, 2017, and entitled “Steviol Glycoside Solubility Enhancers;” U.S. application Ser. No. 16/374,894, filed Apr. 4, 2019 and entitled “Methods for Making Yerba Mate Composition,” which was published on Aug. 1, 2019 as US Patent Application Publication No. 2019/0231834; International Application No. PCT/US2018/054688, filed Oct. 5, 2018 and entitled “Methods for Making Yerba Mate Composition;” U.S. Provisional Application Ser. No. 62/676,722, filed May 25, 2018, and entitled “Methods for Making Yerba Mate Extract Composition;” and International Application No. PCT/US2020/026885 filed Apr. 6, 2020, entitled “Stevia Processing,” and published as WO 2020/210161 on Oct. 15, 2020, each of which is incorporated herein by reference. For example, sensory modifier may be isolated from a botanical source that comprises one or more of monocaffeoylquinic acid, dicaffeoylquinic acid, and salts thereof. For example, yerba mate biomass and stevia biomass can be used to prepare sensory modifier. In one exemplary process, sensory modifier is prepared from commercially obtained comminuted yerba mate biomass. Briefly, yerba mate biomass is suspended in 50% (v/v) ethanol/water, shaken for at least 1 hour, and the resulting mixture filtered to obtain an initial extract. The initial extract is diluted to 35% (v/v) ethanol with water and refiltered. Refiltered permeate is then applied to a column of AMBERLITE® FPA 53 resin that has been equilibrated in 35% (v/v) ethanol/water and the column permeate is discarded. The column is washed with 35% (v/v) ethanol/water and the column permeate is discarded. The column is then eluted with 10% (w/v) FCC grade sodium chloride in 50% (v/v) ethanol/water and the eluent retained. Nitrogen gas is blown at room temperature over a surface of the eluent to remove ethanol and reduce the eluent to 1/3 of its original volume. The reduced volume eluent is then filtered through a 0.2 μm polyethersulfone filter and then decolored by passing through a 3 kDa molecular weight cutoff membrane. The decolored permeate is retained and desalted by passing through a nanofiltration membrane. The desalted permeate is then freeze-dried to obtain the sensory modifier. This process is also suitable to obtain sensory modifier from stevia biomass and can be adapted to obtain sensory modifier from other botanical sources for example those described above. Another exemplary process may be the process outlined in Example 3 of PCT Application No. WO2020/210161, published Oct. 15, 2020, which is incorporated by reference herein.

In some aspects, the sensory modifier can be a blend of sensory modifier isolated from more than one botanical source.

Some compounds can adversely impact flavor or aroma of a cocoa composition or an aqueous solution or food product prepared therefrom. Certain sensory modifiers, such as those prepared from plant extract do not include one or more of the compounds shown in Table 2, or any combination thereof, above the disclosed preferred content levels. All preferred content levels are stated as weight percent on a dry weight basis. Certain commercially desirable solid (dry) sensory modifiers do not include more than the preferred level of any of the compounds listed in Table 2. For those compounds listed that are acids, the compound may be present in acid form and/or in slat form.

TABLE 2

| Class of | Preferred Content | % wt of compounds in steviol glycoside |
|---|---|---|
| compounds | Level (% wt) | solubility enhancer solid (dry) compositions |
| Organic acids | <3%, preferably | malonate, malonic acid, oxalate, oxalic acid, |
| | <2%, <1%, or 0% | lactate, lactic acid, succinate, succinic acid, |
| | | malate, malic acid, citrate, citric acid |
| | <0.5%, preferably | tartrate, tartaric acid, pyruvate, pyruvic acid, |
| | <0.25% or 0% | fumarate, fumaric acid, ascorbic acid, sorbate, |
| | | sorbic acid, acetate, acetic acid |
| Inorganic acids | <1%, preferably | sulfate, sulfuric acid, phosphate, phosphoric |
| | <0.5% or 0% | acid, nitrate, nitric acid, nitrite, nitrous acid, |
| | | chloride, hydrochloric acid, ammonia, |
| | | ammonium |
| Flavanoids, | <5%, preferably | quercetin, kaempferol, myricetin, fisetin, |
| isoflavanoids, and | <4%, <3%, or <2%, | galangin, isorhamnetin, pachypodol, rhamnazin, |
| neoflavanoids | more preferably | pyranoflavonols, furanoflavonols, luteolin, |
| | <1%, <0.5%, or 0% | apigenin, tangeritin, taxifolin (or |
| | | dihydroquercetin), dihydrokaempferol, |
| | | hesperetin, naringenin, eriodictyol, |
| | | homoeriodictyol, genistein, daidzein, glycitein |
| Flavanoid | <5%, preferably | hesperidin, naringin, rutin, quercitrin, luteolin- |
| glycosides | <4%, <3%, or <2%, | glucoside, quercetin-xyloside |
| | more preferably | |
| | <1%, <0.5%, or 0% | |
| Anthocyanidins | <5%, preferably | cyanidin, delphinidin, malvidin, pelargonidin, |
| | <4%, <3%, or <2%, | peonidin, petunidin |
| | more preferably | |
| | <1%, <0.5%, or 0% | |
| Tannins | <1%, preferably | tannic acid |
| | <0.5%, <0.25%, or | |
| | 0% | |
| Amino acids + | <0.1%, preferably | alanine, arginine, asparagine, aspartic acid, |
| total protein | <0.05%, or 0% | cysteine, glutamine, glutamic acid, glycine, |
| | | histidine, isoleucine, leucine, lysine, methionine, |
| | | phenylalanine, proline, serine, threonine, |
| | | tryptophan, tyrosine, and valine |
| Total Fat | <1%, preferably | monoglycerides, diglycerides, triglycerides |
| | <0.5%, <0.25%, or | |
| | 0% | |
| Monosaccharides, | <1% | glucose, fructose, sucrose, galactose, ribose, |
| disaccharides, and | | trehalose, trehalulose, lactose, maltose, |
| polysaccharides | | isomaltose, isomaltulose, mannose, tagatose, |
| | | arabinose, rhamnose, xylose, dextrose, erythrose, |
| | | threose, maltotriose, panose |
| Sugar alcohols | <1% | glycerol, sorbitol, mannitol, xylitol, maltitol, |
| | | lactitol, erythritol, isomalt, inositol |
| Dietary fiber | <0.1%, preferably | acacia (arabic) gum, agar-agar, algin-alginate, |
| | <0.05% or 0% | arabynoxylan, beta-glucan, beta mannan, |
| | | carageenan gum, carob or locust bean gum, |
| | | fenugreek gum, galactomannans, gellan gum, |
| | | glucomannan or konjac gum, guar gum, |
| | | hemicellulose, inulin, karaya gum, pectin, |
| | | polydextrose, psyllium husk mucilage, resistant |
| | | starches, tara gum, tragacanth gum, xanthan |
| | | gum, cellulose, chitin, and chitosan |
| Saponins | <2%, preferably | glycosylated ursolic acid and glycosylated |
| | <1%, <0.5%, | oleanolic acid |
| | <0.25%, or 0% | |
| Terpenes other | <2%, preferably | eugenol, geraniol, geranial, alpha-ionone, beta- |
| than saponins and | <1%, <0.5%, | ionone, epoxy-ionone, limonene, linalool, |
| steviol glycoside | <0.25%, or 0% | linalool oxide, nerol, damascenone |
| compounds | | |
| Lipid oxidation | <2%, preferably | Decanone, decenal, nonenal, octenal, heptenal, |
| products | <1%, <0.5%, | hexenal, pentenal, pentenol, pentenone, |
| | <0.25%, or 0% | hexenone, hydroxynonenal, malondialdehyde |
| Polycyclic | <0.1%, preferably | Acenaphthene, Acenaphthylene, Anthracene, |
| Aromatic | <0.05% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a,h)anthracene, Fluoranthene, Fluorene, |
| | | Indeno(1,2,3-cd)pyrene, Naphthalene, |
| | | Phenanthrene, Pyrene |
| Other compounds | <0.1%, preferably | chlorophyll, furans, furan-containing chemicals, |
| | <0.05% or 0% | theobromine, theophylline, and trigonelline |
| | <1%, preferably | saponins |
| | <0.5%, <0.25%, or | |
| | 0% | |

In some aspects, the sensory modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

The present invention can be better understood by reference to the following examples which are offered by way of illustration. The present invention is not limited to the examples given herein.

### EXAMPLES

### Materials and Methods

The tested sensory modifier was a mixture of monocaffeoylquinic and dicaffeoylquinic acids and salts prepared from yerba mate and having a ratio of salt fraction to acid fraction of 65:35. Table 3 lists the contents and source of various components used in these Examples.

TABLE 3

| Component | Ingredients | Source |
|---|---|---|
| Sensory Modifier | Mixture containing mono- and | Cargill, Inc. |
| | dicaffeoylquinic acids and salts, | (Wayzata, MN) |
| | prepared from Yerba mate | |
| | 65:35 ratio of salt:acid from | |
| Steviol Glycoside (SG) | ≥85 wt % rebaudioside M | Cargill, Inc. |
| Sweetener | ≈3-15 wt % rebaudioside D | (Wayzata, MN) |

Assays were carried out to characterize the sensory attributes of cocoa, chocolate, and chocolate like compositions with various amounts of sensory modifier and/or sweetener, for example a no-calorie sweetener such as a steviol glycoside sweetener. Sensory attributes of the compositions were tested by a panel of individuals that are experienced in sensory testing. The experienced panelists assessed intensities of sensory attributes such as bitterness, sweetness, cocoa flavor, cooked milk flavor, and cream flavor, and temporal sensory attributes such as sweetness linger. Assays in which a particular methodology or panel were used are noted in the individual examples below.

### Example 1—Milk Chocolate Coating Compositions

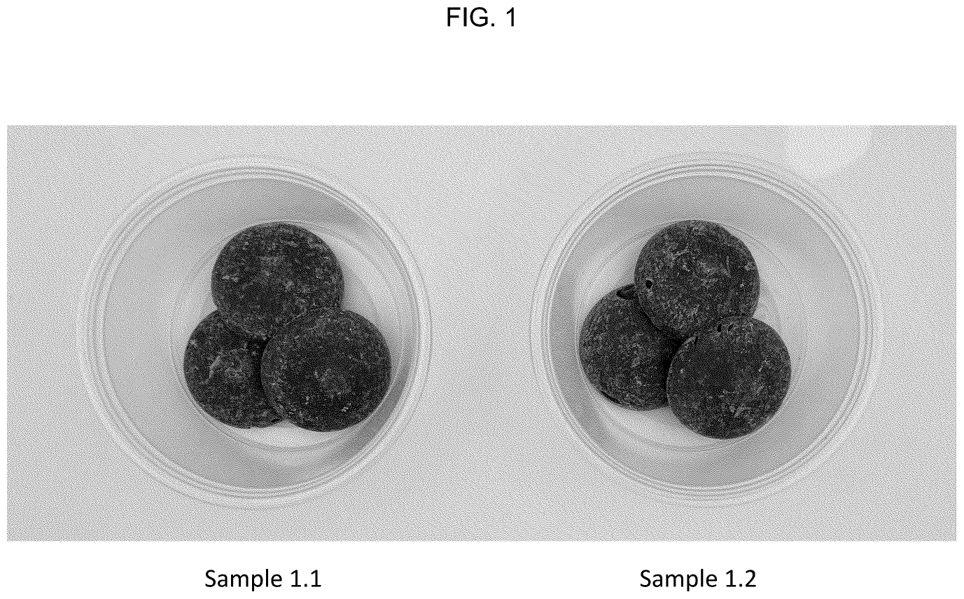

Milk chocolate coating compositions were prepared with the ingredients outlined in Table 4. To prepare the milk chocolate coating compositions, a pre-mix paste was formed with crystalline maltitol, a portion of the cocoa butter, cocoa liquor, powdered whole milk, and anhydrous milkfat to a fat level of around 27.5% and the pre-mix paste was refined to a particle size of 24 microns. The refined flake was melted down with lecithin and additional cocoa butter was added to a total fat content of around 35%. Either the SG sweetener or the combination of Sensory modifier and SG sweetener were added to the melted, refined paste before cooling down to temper, allowing for around 20 minutes for the sweetener or sweetener sensory modifier combination to mix in and incorporate. Tempering was performed manually. Following tempering, the product was cooled to 50° F. Solids and fat content of the samples are reported in Table 5 and a picture of the samples are provided in FIG. 1.

TABLE 4

Sample

| Ingredients (wt %) | 1.1 | 1.2 |
|---|---|---|
| Maltitol (crystalline) | 50.000 | 50.000 |
| Cocoa butter | 23.447 | 23.410 |
| Cocoa liquor (53% fat) | 11.000 | 11.000 |
| Powdered whole milk (28.5% fat) | 13.000 | 13.000 |
| Anhydrous milkfat | 2.000 | 2.000 |
| Lecithin | 0.500 | 0.500 |
| Sensory Modifier | — | 0.038 |
| Steviol glycoside sweetener | 0.053 | 0.053 |

TABLE 5

Samples

| | 1.1 | 1.2 |
|---|---|---|
| Non-fatty Cocoa solids | 5.170% | 5.170% |
| Non-fatty Milk solids | 9.295% | 9.295% |
| Cocoa fat content | 29.278% | 29.240% |
| Milk fat content | 5.705% | 5.705% |
| Total fat content | 35.066% | 35.028% |

### Example 2—Sensory Analysis of Milk Chocolate Coating Compositions

Assays were carried out to characterize the sensory attributes of the milk chocolate coating compositions described in Example 1. Sensory attributes of the milk chocolate coating compositions were tested by a panel of 9 individuals, trained in sensory testing, using a roundtable consensus approach. Before evaluation of the milk chocolate coating compositions, the experienced panelists were trained on the sensory attributes of sweetness, bitterness, cocoa flavor, cooked milk flavor, and cream flavor. The panelists also calibrated each sensory attribute against reference samples, as outlined in Table 6.

TABLE 6

| Attributes | | Reference |
|---|---|---|
| Taste | Sweetness | Sucrose; See Standardized Sweetness |
| | | Intensity Test |
| | Bitterness | Caffeine; See Standardized Bitterness |
| | | Intensity Test |
| Flavor | Cocoa | GERKENS ™ Amber Cocoa Powder; 10 g |
| | | in 490 g water |
| | Cooked | NESTLE ™ CARNATION ™ Evaporated |
| | Milk | Milk and ESSENTIAL EVERYDAY ™ Instant |
| | | Nonfat Dry Milk |
| | Cream | KEMPS ™ Select Heavy Whipping Cream |

To test each sample, each panelist placed approximately 3 g of the sample into their mouth, chewed 3-4 times, let the sample melt for approximately 10 seconds, then recorded a value and comments for the attributes being tested. Between tasting samples, the panelists were able to cleanse their palates with water. Results are outlined in Table 7 as an average of panelist scores with panelists evaluating samples in duplicate.

TABLE 7

Samples

| | | |
|---|---|---|
| Attributes | 1.1 | 1.2 |

| | | | |
|---|---|---|---|
| Taste | Sweetness | 8.3 | 8.6 |
| | Bitterness | 2.6 | 2.9 |
| Flavor | Cocoa | 4.5^{b} | 5.5^{a} |
| | Cooked Milk | 4.3^{a} | 3.3^{b} |
| | Cream | 1.8^{b} | 3.3^{a} |
| Aftertaste | Sweetness linger 15 s | 5.3 | 5.6 |
| | Sweetness linger 30 s | 3.4 | 3.9 |

### Example 3—Chocolate Milk Compositions

A chocolate milk beverage was prepared by adding the components listed in Table 8 at the listed concentrations. The components were combined, warmed to 32° C., then homogenized using a high-shear mixer. After the components were all dissolved or uniformly suspended, the mixture was heated in a microwave to 88.8° C., then allowed to cool on ice.

TABLE 8

| | Concentration |
|---|---|
| Component | (wt %) |
| 1% Milk | 99.057% |
| Steviol glycoside blend; sold under | 0.0235% |
| the tradename VIATECH ™ TS1600 | |
| Kappa carrageenan | 0.0250% |
| Corn starch | 0.300% |
| Non-alkalized cocoa powder | 0.030% |
| (10-12% fat), sold under the tradename | |
| 10/12 AMBER ™ by GERKENS ™ | |
| Alkalized cocoa powder (10-12% fat), | 0.458% |
| sold under the tradename 10/12 RUSSET | |
| PLUS ™ by GERKENS ™ | |
| Salt (NaCl) | 0.087% |
| Vanillin | 0.005% |

The chocolate milk composition was assayed alone and with the addition of 0.0235% of the sensory modifier. The sample containing the sensory modifier had a richer flavor characterized as an increased cocoa flavor and an increased cream flavor.

### Example 4—Reduced Sugar Chocolate Mousse (Prophetic)

A chocolate mousse composition with 25% reduced sugar is prepared adding the components listed in Table 9. To prepare the reduced sugar chocolate mousse, the skim milk and steviol glycoside sweetener are added to a melted mixture of the butter and the emulsifier. The milk and butter mixture are heated to 140° F. prior to the addition of the chocolate liquor. The whole milk and sucromalt are heated in a microwave for 1 minute then added to the milk, butter, and chocolate mixture with vanilla, followed by heating the combination to 200° F. The mixture is held at 200° F. for ten minutes and whisked. The mixture is then cooled to 70° F. with whisking. The sucrose, milk powder, corn starch, salt, erythritol, and inulin is added to the cream cheese which had been creamed, and the mixture is beat until smooth. Finally, the cooled butter mixture is added to the cream cheese mixture and the combination is whipped until fluffy and homogeneous. For samples including the sensory modifier composition, the sensory modifier may be added at a concentration between 0.005% and 0.030% and may be added together with the steviol glycoside sweetener.

TABLE 9

| | Concentration |
|---|---|
| Component | (wt %) |
| Sucrose | 27.0% |
| Whole milk | 18.0% |
| Butter | 12.0% |
| Reduced fat (⅓) cream cheese | 9.8% |
| Chocolate liquor | 6.5% |
| Milk powder | 2.7% |
| Corn starch | 2.2% |
| Skim Milk | 2.0% |
| Mon & Diglyceride emulsifier, sold | 1.5% |
| under the tradename BFP ™ 550 | |
| Vanilla extract | 1.0% |
| Salt (NaCl) | 0.8% |
| Sucromalt | 7.0% |
| Erythritol | 6.6% |
| Inulin | 2.8% |
| Steviol Glycoside Sweetener | 0.02% |

### Example 5—Chocolate Protein Beverage

A dry blended protein powdered beverage product is prepared with the ingredients outlined in Table 10. To prepare the dry blended beverage product half of the total whey protein of the formula is added to a mixer and stirred for about 1 minute. While mixing, the acesulfame potassium, sucralose, vanillin, carrageenan, lecithin, salt, and cocoa powder are added. The last half of the whey protein is added, and the mixture is mixed for 5 minutes. The mixture is stirred for another 2-3 minutes while checking for any clumps. For samples including the sensory modifier, the sensory modifier is added while mixing along with the other ingredients.

To prepare a finished beverage from the dry powdered protein product, 30 g of the dry powder is added to 10 fluid ounces of water or milk in a shaker bottle and shaken until the powder is completely dispersed.

TABLE 10

| | Concentration |
|---|---|
| Component | (wt %) |
| Carrageenan | 0.235% |
| De-oiled canola lecithin | 0.206% |
| Alkalized cocoa powder (10-12% fat), | 5.882% |
| sold under the tradename 10/12 RUSSET | |
| PLUS ™ by GERKENS ™ | |
| Cocoa powder (10-12% fat), sold under | 5.882% |
| the tradename DB82 by GERKENS ™ | |
| Heavily alkalized cocoa powder | 1.471% |
| (10-12% fat), sold under the tradename | |
| 10/12 MIDNIGHT ™ by GERKENS ™ | |
| Salt (NaCl) | 0.926% |
| Sucralose powder | 0.088% |
| Acesulfame potassium | 0.059% |
| Vanillin | 0.147% |
| Whey protein isolate | 85.103% |

### Example 6—Protein Beverage

Assays were carried out to characterize the sensory attributes of whey and soy protein-based chocolate beverages. Dry blended protein powdered beverage products were prepared using the ingredients outlined in the formulations in Table 11 or 12. To prepare the dry blended beverage products half of the total whey protein (or soy protein) of the formula was added to a mixer and stirred for about 1 minute. While continuing to mix, the other powder ingredients (acesulfame potassium, sucralose, vanillin, sunflower lecithin, carrageenan, salt, and cocoa powder) were added. For samples including the sensory modifier, the sensory modifier was added at the same time as these other powder ingredients. Lastly, the remaining whey protein (or soy protein) was added, and the protein powdered beverage system was mixed for an additional 5 minutes to ensure that no clumps existed in the mixture.

To prepare finished beverages from the dry powdered protein products, 30 grams of the dry powder beverage system was added to 10 fluid ounces of water in a shaker bottle. The metal ball for whisking was added to the shaker bottle, which was then sealed with the lid. Each shaker bottle was shaken for about 1 minute to completely disperse the powder. Sensory attribute results are reported in Tables 13 and 14 for the whey and soy based beverages, respectively.

TABLE 11
Whey Protein Beverage

| | Sample (wt %) | | | |
|---|---|---|---|---|
| Ingredient | 6.1 | 6.2 | 6.3 | 6.4 |
| Hydrolyzed whey | 42.954% | 42.854% | 42.804% | 42.704% |
| protein | | | | |
| Whey protein | 42.15% | 42.15% | 42.15% | 42.15% |
| isolate | | | | |
| Carrageenan | 0.23538% | 0.23538% | 0.23538% | 0.23538% |
| Sunflower lecithin | 0.20594% | 0.20594% | 0.20594% | 0.20594% |
| (deoiled) | | | | |
| Alkalized cocoa | 13.23540% | 13.23540% | 13.23540% | 13.23540% |
| powder (10-12% fat), | | | | |
| sold under the | | | | |
| tradename 10/12 | | | | |
| RUSSET PLUS ™ | | | | |
| by GERKENS ™ | | | | |
| Salt | 0.92568% | 0.92568% | 0.92568% | 0.92568% |
| Micronized sucralose | 0.08822% | 0.08822% | 0.08822% | 0.08822% |
| powder | | | | |
| Acesulfame potassium | 0.05881% | 0.05881% | 0.05881% | 0.05881% |
| Vanillin | 0.14706% | 0.14706% | 0.14706% | 0.14706% |
| Sensory Modifier | — | 0.1% | 0.15% | 0.25% |

TABLE 12
Soy Protein Beverage

| | Sample (wt %) | | | |
|---|---|---|---|---|
| Ingredient | 6.5 | 6.6 | 6.7 | 6.8 |
| Soy Protein Isolate | 85.104% | 85.004% | 84.954% | 84.854% |
| Carrageenan | 0.23538% | 0.23538% | 0.23538% | 0.23538% |
| Sunflower lecithin | 0.20594% | 0.20594% | 0.20594% | 0.20594% |
| (deoiled) | | | | |
| Alkalized cocoa | 13.23540% | 13.23540% | 13.23540% | 13.23540% |
| powder (10-12% fat), | | | | |
| sold under the | | | | |
| tradename 10/12 | | | | |
| RUSSET PLUS ™ | | | | |
| by GERKENS ™ | | | | |
| Salt | 0.92568% | 0.92568% | 0.92568% | 0.92568% |
| Micronized sucralose | 0.08822% | 0.08822% | 0.08822% | 0.08822% |
| powder | | | | |
| Acesulfame potassium | 0.05881% | 0.05881% | 0.05881% | 0.05881% |
| Vanillin | 0.14706% | 0.14706% | 0.14706% | 0.14706% |
| Sensory Modifier | — | 0.1% | 0.15% | 0.25% |

TABLE 13
Whey Protein Beverage Sensory Results

| Sensory | Sample | | | |
|---|---|---|---|---|
| Attribute | 6.1 | 6.2 | 6.3 | 6.4 |
| Chocolate | 6 | 5 | 6 | 6 |
| flavor | | | | |
| Sweetness | 5 | 4.5 | 5 | 4.5 |
| Astringent/ | 3 | 3 | 3 | 2 |
| Mouth drying | | | | |
| Bitterness | 4 | 2.5 | 2 | 1 |
| Milky/Dairy | 0 | 2 | 3 | 4 |
| Malty/Grain | 4 | 2 | 0 | 0 |
| Comments | Malty cereal | Less malty, | Faint to slight | More robust |
| | type bitter; | milky/dairy type, | (2.5) green coffee | milk chocolate |
| | cocoa flavor | creamy, hot cocoa | bean type note, | profile, faint |
| | | type chocolate | lower quality | creamer character |
| | | flavor | milk chocolate | |
| | | | profile | |

TABLE 14
Soy Protein Beverage Sensory Results

| Sensory | Sample | | | |
|---|---|---|---|---|
| Attribute | 6.5 | 6.6 | 6.7 | 6.8 |
| Sweetness | 3.5 | 4 | 4.5 | 5 |
| Chocolate | 3 | 4 | 5 | 5 |
| Bitterness | 3 | 2 | 1.5 | 1.5 |
| Beany | 5 | 3 | 2.5 | 1.5 |
| Cardboard | 4.5 | 4 | 3 | 2 |
| Astringent | 4 | 4 | 3.5 | 3 |
| Comments | Quick onset of | Quick onset of | Moving to more | Better upfront |
| | beany note, | sweetness, more | milk chocolate, | sweetness and |
| | artificial | bright chocolate | quicker onset of | beany note |
| | sweetness type | flavor | sweetness | intensity |
| | profile at end | | | reduced |
| | | | | significantly |

### Example 7—Reduced Sugar Chocolate Ice Cream

Assays were carried out to characterize the sensory attributes of unfrozen chocolate ice cream mixes. A reduced sugar chocolate ice cream mix was produced using the ingredients outlined in Table 15. The ice cream product was prepared by standardizing a milk and cream blend with non-fat dry milk under high shear. The stabilizer blend and inulin were added to the standardized milk base under high shear. A dry blend of the sugar, stevia extract, erythritol, vanillin and cocoa powder was then added to the mixture, which was blended under high shear for an additional 10 minutes. The final ice cream mixture was thermally processed by pre-heating to 140° F. (60° C.), homogenizing at 2500 psi (2000 psi 1^{st}/500 psi 2^{nd}), pasteurizing at 185° F. (85° C.) for 30 seconds, then cooled to between 60-65° F.

A 0.500% (w/w) stock solution of the sensory modifier in water was created for addition of the sensory modifier to the unfrozen chocolate ice cream mix. For the 50, 75 and 100 ppm concentrations of the sensory modifier in the ice cream mix as indicated in Table 16, 1.0, 1.5 and 2.0 grams, respectively, of the sensory modifier stock solution was independently mixed with the unfrozen chocolate ice cream mix to achieve a final target weight of 100 grams for each sample.

TABLE 15

| | Concentration |
|---|---|
| Component | (wt %) |
| Skim milk | 4.83% |
| Whole milk | 54.00% |
| 34% fat cream | 23.00% |
| Non-fat dried milk | 1.50% |
| Erythritol | 2.75% |
| Inulin | 3.00% |
| Stevia leaf extract, sold under | 0.024% |
| the tradename VIATECH ™ TS1600 | |
| by CARGILL ™ | |
| Sucrose (granulated cane sugar) | 7.00% |
| Stabilizer blend, sold under the | 0.30% |
| tradename DARITECH ™ FC by | |
| CARGILL ™ | |
| Cocoa powder (10-12% fat), sold | 3.5% |
| under the tradename 10/12 Russet | |
| Plus DR74 ™ by GERKENS ™ | |
| Vanillin | 0.100% |

TABLE 16

| | Sample | | | |
|---|---|---|---|---|
| | 7.1 (unfrozen | 7.2 (unfrozen | 7.3 (unfrozen | 7.4 (unfrozen |
| | mix; 0 ppm | mix; 50 ppm | mix; 75 ppm | mix; 100 ppm |
| | sensory | sensory | sensory | sensory |
| Sensory Attribute | modifier) | modifier) | modifier) | modifier) |
| Bitterness | 4.5 | 3 | 2 | 4 |
| Dairy notes/milky | 4 | 4 | 2.5 | 2 |
| flavor | | | | |
| Cocoa | 6 | 6 | 5 | 4 |
| Sweetness | 4 | 5 | 4 | 4 |
| Astringency/drying | 2.5 | 1.5 | 2 | 6 |
| Creamy/fatty | 0 | 4 | 2 | 2 |
| mouthfeel | | | | |
| Comments | Sweetness | Sweetness | Masking of | Time at peak |
| | perception timed to | forward (in contrast | sweetness, cocoa, and | sweetness was very |
| | milkiness, cocoa | to 7.1 mix) more | bitterness attribute | short, creamy perception |
| | forward, reminiscent | creamy mouthfeel, | intensities, short- | was also short in |
| | of a hot cocoa, | more robust milk | lived or compressed | duration, more prominent |
| | powdery | chocolate profile | chocolate flavor and | powdery characteristics |
| | | relative to7.1 mix, | overall sensory, fruity | from cocoa powder, |
| | | premium milk chocolate | after taste present | earlier onset and more |
| | | profile | | intense astringency, hot |
| | | | | cocoa flavor profile |
| | | | | similar to 7.1 mix |

### Example 8—Reduced Sugar Chocolate Ice Cream

Assays were carried out to characterize the sensory attributes of frozen reduced sugar chocolate ice cream mixes. Reduced sugar chocolate ice cream products were prepared using the ingredients outlined in Table 17. For each sample, the ice cream mix was prepared by standardizing a milk and cream blend with non-fat dry milk under high shear. The stabilizer blend and inulin were added to the standardized milk base under high shear. A dry blend of the sugar, stevia extract, erythritol, vanillin and cocoa powder was then added to the mixture, which was blended under high shear for an additional 10 minutes. The final ice cream mixture was thermally processed by pre-heating to 140° F. (60° C.), homogenizing at 2500 psi (2000 psi 1^{st}/500 psi 2^{nd}), pasteurizing at 185° F. (85° C.) for 30 seconds, then cooled to between 60-65° F. For samples containing the sensory modifier, the sensory modifier was added to the composition with the dry blend of ingredients. The mixture was aged overnight at 4° C. The aged ice cream mixes were then frozen using an industry standard batch ice cream freezer then placed in a blast freezer to harden. Overrun of ice cream was calculated and ranged from 28%-˜33% o.

TABLE 17

| | Sample (wt %) | | |
|---|---|---|---|
| Component | 8.1 | 8.3 | 8.2 |
| Skim milk | 4.826% | 4.816% | 4.821% |
| Whole milk | 54.00% | 54.00% | 54.00% |
| 34% fat cream | 23.00% | 23.00% | 23.00% |
| Non-fat dried milk | 1.50% | 1.5% | 1.5% |
| Erythritol | 2.75% | 2.75% | 2.75% |
| Inulin | 3.00% | 3.00% | 3.00% |
| Stevia leaf extract, sold under | 0.024% | 0.024% | 0.024% |
| the tradename VIATECH ™ | | | |
| TS1600 by CARGILL ™ | | | |
| Sucrose (granulated cane sugar) | 7.00% | 7.00% | 7.00% |
| Stabilizer blend, sold under the | 0.30% | 0.30% | 0.30% |
| tradename DARITECH ™ FC by | | | |
| CARGILL ™ | | | |
| Cocoa powder (10-12% fat), sold | 3.5% | 3.5% | 3.5% |
| under the tradename 10/12 Russet | | | |
| Plus DR74 ™ by GERKENS ™ | | | |
| Vanillin | 0.100% | 0.100% | 0.100% |
| Sensory Modifier | — | 0.010% | 0.005% |

TABLE 18

| Sensory | Sample | | |
|---|---|---|---|
| Attribute | 8.1 (frozen) | 8.2 (frozen) | 8.3 (frozen) |
| Sweetness | 6 | 5 | 6 |
| Chocolate | 5 | 5.5 | 6.5 |
| Creamy | 4 | 0 | 5 |
| Milky | 0 | 5 | 0 |
| Bitterness | 3.5 | 2 | 1 |
| Nutty | 1.5 | 0 | 2.5 |
| Mouth drying | 2 | 2 | 2.5 |
| Comments | Predominantly a | Flavor profile transitioning | Premium milk |
| | dark chocolate | to a more milk chocolate | chocolate profile with |
| | flavor profile | character relative to sample | more sustained and full |
| | | 8.1 (frozen) | sweetness |

### Example 9—Chocolate Pea Protein Beverage

Assays were carried out to characterize the sensory attributes of the chocolate pea protein beverage compositions described below. The chocolate pea protein beverage was prepared according to the ingredients outlined in Table 19. The water was heated to between 100 and 120° F. and the pea protein was added with high shear blending. The pea protein was hydrated for 10 minutes. Following pea protein hydration, the gellan and guar gum thickeners were added under high shear and hydrated for 5 minutes. Following the thickener hydration, the cocoa powder, steviol glycoside sweetener, dipotassium phosphate, and sugar were added and allowed to hydrate for 5 minutes. Next, the oil and flavors were added and the mixture allowed to blend for 5 minutes. Finally, the compositions were thermally processed by pre-heating to 140° F. (60° C.), homogenizing at 2500 psi (2000 psi 1^{st}/500 psi 2^{nd}), and pasteurizing at 185° F. (85° C.) for 30 seconds. Beverage compositions were then stored at 4° C. For samples including the sensory modifier, the sensory modifier was added under shear with the other ingredients following thickener hydration. Sensory attributes of the chocolate pea protein beverages are reported in Table 20.

TABLE 19

| | Sample (wt %) | |
|---|---|---|
| Component | 9.1 | 9.2 |
| Coconut oil | 2.75% | 2.75% |
| Thickening agent (guar gum and gellan | 0.065% | 0.055% |
| gum) | | |
| Granulated cane sugar | 3.00% | 3.00% |
| Dipotassium phosphate | 0.20% | 0.20% |
| Cocoa powder (10-12% fat), sold under | 2.20% | 2.20% |
| the tradename 10/12 Russet Plus DR74 ™ | | |
| by GERKENS ™ | | |
| Cocoa powder (10-12% fat), sold under | 0.10% | 0.10% |
| the tradename Amber 10/12 NE by | | |
| GERKENS ™ | | |
| Flavor (flavor masker and dark chocolate | 0.376% | 0.376% |
| flavor) | | |
| Steviol glycoside sweetener | 0.0222% | 0.0222% |
| Maltodextrin | — | 1.75% |
| Pea protein, sold under the tradename | 9.5% | 9.5% |
| PURIS ™ Pes 2.0 by PURIS ™ | | |
| Water | 81.7868% | 80.0310% |
| Sensory Modifier | — | 0.0158% |

TABLE 20

| Sensory | Sample | |
|---|---|---|
| Attribute | 9.1 | 9.2 |
| Chalky | 2.5 | 2 |
| Astringent/ | 4 | 3 |
| Mouth drying | | |
| Bitterness | 3 | 1.5 |
| Beany | 4.5 | 2 |
| Cocoa | 6 | 6 |
| Sweetness | 5 | 6.5 |
| Comments | Aromatics and overall | Aromatics and overall |
| | flavor comes across as | flavor comes across as |
| | dark chocolate note with | smooth/creamy milk |
| | metallic aftertaste | chocolate type cocoa notes |
| | | with additional slight to |
| | | milk creaminess attribute |
| | | reminiscent of dairy type |
| | | chocolate milk |

### Example 10—Reduced Sugar Milk Chocolate

Assays were carried out to characterize the sensory attributes of reduced sugar milk chocolate coatings. The reduced sugar milk chocolate coatings were prepared according to Table 21. To prepare the milk chocolate coating compositions, a pre-mix paste was formed with erythritol, a portion of the cocoa butter, cocoa liquor, powdered whole milk, and anhydrous milkfat to a fat level of around 27.5% o and the pre-mix paste was refined to a particle size of 24 microns. The refined flake was melted down with lecithin and additional cocoa butter was added to a total fat content of around 35% o. Either the steviol glycoside sweetener or the combination of Sensory modifier and steviol glycoside sweetener were added to the melted, refined paste before cooling down to temper, allowing for around 20 minutes for the sweetener or sweetener sensory modifier combination to mix in and incorporate. Tempering was performed manually. Following tempering, the product was cooled to 50° F. Sensory attributes of the compositions are reported in Table 22.

TABLE 21

Sample (wt %)

| Component | 10.1 | 10.2 |
|---|---|---|
| Cocoa butter | 23.419% | 23.410% |
| Cocoa liquor | 11.004% | 11.00% |
| Anhydrous milkfat | 2.001% | 2.00% |
| Lecithin | 0.500% | 0.500% |
| 28.5% fat whole milk powder | 13.005% | 13.00% |
| Erythritol | 35.013% | 35.00% |
| Inulin | 15.006% | 15.00% |
| Steviol glycoside sweetener | 0.53% | 0.0525% |
| Sensory modifier | — | 0.0375% |

TABLE 22

| Sensory | Sample | |
|---|---|---|
| Attribute | 10.1 | 10.2 |
| Sweetness | 5 | 4 |
| Cocoa | 3 | 2.5 |
| Nonfat dry milk | 3 | 1.5 |
| Creamy | 4 | 1 |
| Cooling | 3 | 2 |
| Caramel | 2 | 0 |
| Bitterness | 1 | 3 |
| Chalky/Mouthcoating | 0 | 3.5 |
| Comments | More consistent | Brief time at peak |
| | sweetness profile, | sweetness, more of a |
| | cooling aftertaste | dark chocolate profile, |
| | covers any latent | lingering bitter |
| | bitterness | aftertaste |

1. A composition comprising:
cocoa liquor, cocoa powder, or combinations thereof,
milk solids, milk solid alternatives or combinations thereof,
a sugar substitute; and
a sensory modifier comprising
a dicaffeoylquicid acid or salt thereof; and
at least one compound selected from the group consisting of monocaffeoylquinic acids, monoferuloylquinic acids, diferuloylquinic acids, monocoumaroylquinic acids, dicoumaroylquinic acids, and salts thereof.

2. The composition of claim 1, wherein the sugar substitute is selected from the group consisting of steviol glycosides, mogrosides, sucralose, acesulfame K, aspartame, saccharin, erythritol, maltitol, lactitol, sorbitol, mannitol, xylitol, allulose, and combinations thereof.

3. (canceled)

4. The composition of claim 1, wherein the sugar substitute comprises a steviol glycoside selected from the group consisting of rebaudioside M, rebaudioside D, rebaudioside A, and combinations thereof.

5. The composition of claim 4, wherein the steviol glycoside and the sensory modifier are present in the composition at a ratio between 1:0.3 and 1:3.

6. (canceled)

7. (canceled)

8. The composition of claim 1, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof.

9. The composition of claim 1, wherein the total of all dicaffeoylquinic acids and dicaffeoylquinic salts present in the sensory modifier comprises 20% (wt) or more of a total weight of the sensory modifier.

10. The composition of claim 1, wherein the sensory modifier comprises a monocaffeoylquinic component selected from the group consisting of chlorogenic acid, neochlorogenic acid, cryptochlorogenic acid, and salts thereof.

11. The composition of claim 1, wherein the sensory modifier comprises a monocaffeoylquinic component and a dicaffeoylquinic component that together comprise more than 50% (wt), of the sensory modifier.

12. The composition of claim 1, wherein the composition comprises 0.001 (wt) % to 1.0 (wt) % of the sensory modifier.

13. The composition of claim 1, wherein the composition additionally comprises cocoa butter.

14. The composition of claim 1, wherein the composition comprises at least 2% by weight non-fatty cocoa solids.

15. The composition of claim 1, wherein the composition comprises at least 5% by weight non-fatty milk solids.

16. The composition of claim 1, wherein the composition additionally comprises an emulsifier.

17. The composition of claim 1, wherein the composition additionally comprises a bulking agent.

18. The composition of claim 1, wherein cocoa flavor and/or cream flavor of the composition is increased relative to an equivalent composition lacking the sensory modifier.

19. (canceled)

20. The composition of claim 1, wherein cooked milk flavor of the composition is decreased relative to an equivalent composition lacking the sensory modifier.

21. (canceled)

22. A food or beverage product comprising the composition of claim 1.

23. A method for increasing cocoa flavor and/or cream flavor in a cocoa composition, the method comprising,
adding to a cocoa composition a sensory modifier comprising a dicaffeoylquicid acid or salt thereof and at least one compound selected from the group consisting of monocaffeoylquinic acids, monoferuloylquinic acids, diferuloylquinic acids, monocoumaroylquinic acids, dicoumaroylquinic acids, and salts thereof,
wherein the cocoa composition comprises (i) cocoa powder, cocoa liquor, or combinations thereof, and (ii) milk solids, milk solids alternatives, or combinations thereof, and
wherein cocoa flavor and/or cream flavor is increased relative to an equivalent cocoa composition lacking the sensory modifier.

24. The method of claim 23, wherein the sensory modifier is added to the cocoa composition in an amount effective to increase the cocoa flavor and/or cream flavor by at least 1 unit relative a comparable composition lacking the sensory modifier, wherein the cocoa flavor score and/or cream flavor score are determined by at least four panelists experienced in sensory testing using a roundtable methodology using a scale of 0 to 9 with a score of 0 indicating no flavor and a score of 9 indicating extreme flavor.

25.-35. (canceled)

36. The method of claim 23, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof.

37. The method of claim 23, wherein the total of all dicaffeoylquinic acids and dicaffeoylquinic salts present in the sensory modifier comprises 20% (wt) or more of a total weight of the sensory modifier.

38. (canceled)

39. The method of claim 23, wherein the sensory modifier comprises a monocaffeoylquinic component and a dicaffeoylquinic component that together comprise more than 50% (wt) of the sensory modifier.

40.-45. (canceled)
